(19) United States
(12) Patent Application Publication
(10) Pub. No.: US 2008/0067251 A1
(43) Pub. Date: Mar. 20, 2008

(54) Method Of and System For Generating Laser Processing Data, Computer Program For Generating Laser Processing Data and Laser Marking System

(75) Inventors: Koji Yoshimoto, Osaka (JP); Mamoru Idaka, Osaka (JP)

Correspondence Address: KILYK & BOWERSOX, P.L.L.C., 400 HOLIDAY COURT, SUITE 102, WARRENTON, VA, 20186, US

(73) Assignee: KEYENCE CORPORATION, Osaka (JP)

(21) Appl. No.: 11/855,448

(22) Filed: Sep. 14, 2007

(30) Foreign Application Priority Data
Sep. 15, 2006 (JP) 2006-251700

(51) Int. Cl. G06K 7/10

(52) U.S. Cl. 235/462.32

(57) ABSTRACT

Laser processing data based on which a laser processing system scans a work with a laser beam adjustable in focal distance in two dimensions is generate by specifying a two-dimensional pattern in an X-Y coordinate plane and a shift pitch at which the two-dimensional pattern is shifted in a Z-axis direction and repeatedly shifting the two-dimensional pattern at the shift pitch in the Z-axis direction in synchronism with the scan with the two-dimensional pattern.

### BACKGROUND OF THE INVENTION

1. Field of the Invention

The present invention relates to a method of and system for generating laser processing data representing a processing pattern based on which a laser processing system processes a subject surface by varying a focal distance of a laser beam during a scan of a subject surface in two dimensions by the laser beam, a computer program for implementing the method of generating the laser processing data, and a laser marking system including the system for generating the laser processing data.

2. Description of Related Art

Laser processing systems are used to process a given surface of a work (work surface) by scanning the work surface in two dimensions with a laser beam generated by a laser oscillator. The laser beam focused on the work surface is moved in X and Y directions in a surface perpendicular to an optical axis of an X-Y scanner. Such a laser processing system is widely used as a laser marking system to print a pattern comprising characters and/or a barcode on work surfaces. In addition, such a laser processing system can be used to perform a laser cutting job or a laser drilling job for cutting or drilling a relatively thin plate-work. In laser cutting or laser drilling, it is essential in order for the laser processing system to control a depth of cutting or drilling, namely a processed distance in an Z-axis direction, by varying a laser irradiation dose at a point in an X-Y plane. This is performed by, for example, increasing laser power so as to increase energy density of a laser beam or by decreasing a scan speed with a laser beam.

However, because a laser-processed line is made thick when increasing energy density of a laser beam or because a sharp bore surface is hardly attained due to blurring of a laser beam spot with an increase in processing depth, it is hard to perform a precise laser cutting job. In addition, it is impossible to form a processed or cut surface changing in shape in a direction of cutting depth. On the other hand, developments of laser processing systems which are capable of scanning a work surface in three dimensions with a laser beam by varying a laser beam size so as thereby to vary a focal distance of the laser beam are under way into actual utilization. As disclosed in, for example, Japanese Unexamined Patent Publication No. 11-28586, such a laser processing system realizes laser processing with a three-dimensional pattern at a high degree of freedom. The laser processing system is therefore enabled to perform three-dimensional processing or cutting with high precision because there is no need to vary a laser irradiation dose for the purpose of controlling a processing or cutting depth.

It is essential for users of the three-dimensional processing system to prepare three-dimensional processing patterns which cause users troubles and difficulties in pattern design work as compared to two-dimensional processing patters. At the same time, in order to form a desired cut surface on a work by laser processing, it is indispensable to prepare complicated processing patterns in which a work is scanned at specified intervals with a laser beam. Such a pattern design is troublesome even in the case of two-dimensional processing pattern. It is regarded as quite natural that the pater design is quite difficult when intending to gain a desired cut surface in a three-dimensional space. Furthermore, because, in order to perform precise processing, it is necessary to stop down a laser beam in spot size as small as possible, when forming a thick cut line with high precision, a complicated processing pattern is designed so that a scan with the laser ban repeatedly takes place until an intended cut width is gained. That is, in order to form a thick cut line or a cut surface greater in width than a minuscule laser beam spot, a complicated processing pattern is required not exclusively for three-dimensional processing but for forming a thick cut line and a wide cut surface.

### SUMMARY OF THE INVENTION

It is therefore an object of the present invention to provide a method of and a system for generating laser processing data representing a processing pattern based on which a laser processing system is enabled to form a cut line or a cut surface greater in width than a spot size of laser beam.

The foregoing and other features of the present invention are accomplished by a laser processing data generating system for generating three-dimensional laser processing data based on which a three-dimensional laser processing system is controlled so that two-dimensional scanning means scans a work surface in two dimensions with a laser beam and focal distance varying means varies a focal distance of the laser beam. The laser processing data generating system comprises subject pattern specifying means for specifying, at a user's option, subject pattern information about a two-dimensional subject pattern and a processing surface profile of a work which is processed by the three-dimensional laser processing system, subject pattern data generating means for generating data based on which the two-dimensional scanning means and the focal distance varying means are controlled according to the subject pattern information and the processing surface profile, respectively, processing pattern specifying means for specifying, at a user's option, a two-dimensional processing pattern and a shift pitch at which the two-dimensional processing pattern is shifted, continuously or intermittently, and processing pattern data generating means for generating processing data based on which the two-dimensional scanning means and the focal distance varying means are controlled so that, while two-dimensional scanning means repeats a scan with the two-dimensional processing pattern, the focal distance varying means varies the focal distance at the shift pitch in synchronism with the scan with the two-dimensional processing pattern.

The processing data generating system is preferred to comprise rate-of-change specifying means for specifying, at a user's option, a rate of change in size of the processing pattern, wherein the processing pattern data generating means generates the processing data so that the two-dimensional processing pattern is changed in size at the rate of change every shift of the two-dimensional processing pattern. The processing data generating system is preferred to further comprise shift frequency specifying means for specifying the number of shifts of the scan with the two-dimensional processing pattern, wherein the processing pattern data generating means generates the processing data so that the scan with the two-dimensional processing pattern is repeated the number of shift.

By means of the processing data generating system capable of generating a three-dimensional processing pattern by specifying two-dimensional subject pattern information and a three-dimensional profile of printing surface at the user's option, it is facilitated to obtain a three-dimensional processing pattern such as a cutting pattern for engraving a work with a subject pattern including thick cut lines or a cut surface greater in width than a minuscule laser beam spot by specifying a simplified two-dimensional processing pattern and a shift pitch at which the simplified two-dimensional processing pattern is continuously or intermittently shifted. Conventionally, although the use of a minuscule laser beam spot realizes processing of a sharp profile of pattern with high precision, it imposes difficulties in pattern design on users if intending to engrave a thick cut line or a cut surface greater in width than the minuscule laser beam spot. By contrast, the processing data generating system enables users to automatically create a three-dimensional processing pattern by means of specifying a simplified two-dimensional processing pattern and a shift pitch at which the simplified two-dimensional processing pattern is continuously or intermittently shifted and redounds on precise laser processing by reduced man-hour.

In particular, when it is intended to engrave a three-dimensional subject pattern having a depth greater than a laser beam spot, a three-dimensional processing pattern is easily created. For instance, when engraving a three-dimensional pattern having a two-dimensional pattern in a reference surface of a work and a depth greater than the laser beam spot in a direction perpendicular to the reference plane, a three-dimensional processing pattern sufficiently precise enough to realize a laser processing task with high precision is easily created.

According to another embodiment, a laser processing data generating method comprises the steps of specifying, at a user's option, subject pattern information about a two-dimensional subject pattern and a processing surface profile of a work which is processed by the three-dimensional laser marking system; generating data based on which the two-dimensional scanning means and the focal distance varying means are controlled according to subject pattern information and the processing surface profile, respectively; specifying, at a user's option, a two-dimensional processing pattern and a shift pitch at which the two-dimensional processing pattern is shifted; and generating processing data based on which the two-dimensional scanning means and the focal distance varying means are controlled so that, while thje two-dimensional scanning means repeats a scan with the two-dimensional processing pattern, the focal distance varying means varies the focal distance at the shift pitch in synchronism with the scan with the two-dimensional processing pattern.

According to still another embodiment, the computer program generates three-dimensional laser processing data based on which a three-dimensional laser marking or processing system is controlled so that two-dimensional scanning means scans a work surface in two dimensions by a laser beam and focal distance varying means varies a focal distance of the laser beam. The computer program for generating three-dimensional laser processing data comprises a function of specifying, at a user's option, subject pattern information about a two-dimensional subject pattern and a processing surface profile of a work which is processed by the three-dimensional laser marking system; a function of generating data based on which the two-dimensional scanning means and the focal distance varying means are controlled according to subject pattern information and the processing surface profile, respectively; a function of specifying, at a users option, a two-dimensional processing pattern and a shift pitch at which the two-dimensional processing pattern is shifted; and a function of generating processing data based on which the two-dimensional scanning mans and the focal distance varying means are controlled so that, while the two-dimensional scanning means repeats a scan with the two-dimensional processing pattern, the focal distance varying means varies the focal distance at the shift pitch in synchronism with the scan with the two-dimensional processing pattern.

According to a further embodiment, the laser marking system for marking a work surface with a pattern by a laser beam comprises two-dimensional scanning means for scanning the work surface in two dimensions by a laser beam; focal distance varying means for varies a focal distance of the laser beam by varying a beam size of the laser beam; subject pattern specifying means for specifying, at a user's option, subject pattern information about a two-dimensional subject pattern and a processing surface profile of a work which is processed by the three-dimensional laser marking system; marking control means for controlling the two-dimensional scanning means and the focal distance varying means are controlled according to subject pattern information and the processing surface profile, respectively; processing pattern specifying means for specifying, at a user's option, a two-dimensional processing pattern and a shift pitch at which the two-dimensional processing pattern is shifted; and processing control means for controlling the two-dimensional scanning means and the focal distance varying means so that, while the two-dimensional scanning means repeats a scan with the two-dimensional processing pattern, the focal distance varying means varies the focal distance at the shift pitch in synchronism with the scan with the two-dimensional processing pattern.

### BRIEF DESCRIPTION OF THE DRAWINGS

The foregoing and other objects and features of the present invention will be clearly understood from the following detailed description when reading with reference to the accompanying drawings wherein same or similar parts or mechanisms are denoted by the same reference numerals throughout the drawings and in which:

FIG. 1 is a block diagram schematically illustrating a laser processing apparatus according to an embodiment;

FIG. 2 is a perspective view showing an internal arrangement of a laser excitation unit;

FIG. 3 is a schematic view of a laser oscillation unit;

FIG. 4A is a front view of a beam expander;

FIG. 4B is a sectional view of a beam expander;

FIG. 5 is an explanatory view for explaining operation of a Z-axis scanner by the beam expander in which a focal length is short;

FIG. 6 is an explanatory view for explaining operation of the Z-axis scanner by the beam expander in which a focal length is long;

FIG. 7 is a perspective view of an X-Y scanner;

FIG. 8 is a perspective view of an optical system of the laser processing system as seen in one direction;

FIG. 9 is a perspective view of the optical system of the laser processing system as seen in opposite direction;

FIG. 10 is a side view of a scanning unit;

FIG. 11 is a schematic block diagram illustrating a laser processing system according to an embodiment;

FIG. 12 is a schematic block diagram illustrating a system architecture of a laser processing data setting system;

FIG. 13 is a photographic illustration of a user interface window or edit display window in a 2D edit mode;

FIG. 14 is a photographic illustration of the edit display window in a 2D edit mode;

FIG. 15 is a photographic illustration of the edit display window in which a three-dimensional display of a processing pattern is shown;

FIG. 16 is a photographic illustration of the edit display window with a 3D viewer is displayed

FIG. 17 is a photographic illustration of the edit display window for setting a printing surface profile;

FIG. 18 is a photographic illustration of the edit display window for specifying an elementary profile;

FIG. 19 is a photographic illustration of the edit display window for entering information about two-dimensional subject pattern;

FIG. 20 is a photographic illustration of the edit display window for choosing ZMAP data file;

FIG. 21 is a photographic illustration of the edit display window in which a profile of a printing surface is displayed in three dimensions;

FIG. 22 is a photographic illustration of the edit display window in which a representation of three-dimensional profile data defined by a ZMAP data file is displayed over a printing surface;

FIG. 23 is a photographic illustration of the edit display window in which a defective printable area of a printing surface is highlighted;

FIG. 24 is a photographic illustration of the edit display window in a 2D edit mode for data setting;

FIG. 25 is a photographic illustration of the edit display window in which a broken line is chosen as a two-dimensional processing pattern;

FIG. 26 is a photographic illustration of the edit display window in which a counterclockwise circle is chosen as a two-dimensional processing pattern;

FIG. 27 is a photographic illustration of the edit display window in which a tab for setting processing conditions is chosen;

FIG. 28 is a photographic illustration of the edit display window in a 3D edit mode;

FIG. 29 is a photographic illustration of the edit display window for setting a three-dimensional cutting pattern;

FIG. 30 is a photographic illustration of the edit display window in which no-shift of a fixed point is chosen;

FIG. 31 is a photographic illustration of the edit display window in which a continuous-shift of a fixed point is chosen;

FIG. 32 is a photographic illustration of the edit display window in which an intermittent-shift of a fixed point is chosen;

FIG. 33 is a photographic illustration of the edit display window for setting processing conditions of two-dimensional processing;

FIG. 34 is a photographic illustration of the edit display window in which no-shift of a straight line is chosen;

FIG. 35 is a photographic illustration of the edit display window in which a continuous-shift of a straight line is chosen;

FIG. 36 is a photographic illustration of the edit display window in which an intermittent-shift of a straight line is chosen;

FIG. 37 is a photographic illustration of the edit display window in which no-shift of a circle line is chosen;

FIG. 38 is a photographic illustration of the edit display window in which a continuous-shift of a circle line is chosen;

FIG. 39 is a photographic illustration of the edit display window in which an intermittent-shift of a circle line is chosen;

FIG. 40 is a photographic illustration of the edit display window in which no-shift of a circular arcuate line is chosen;

FIG. 41 is a photographic illustration of the edit display window in which a continuous-shift of a circular arcuate line is chosen;

FIG. 42 is a photographic illustration of the edit display window in which an intermittent-shift of a circular arcuate line is chosen;

FIG. 43 is a photographic illustration of the edit display window in which a continuous-shift of a cone shape is chosen;

FIG. 44 is a photographic illustration of the edit display window in which an intermittent-shift of a cone shape is chosen;

FIG. 45 is a photographic illustration of the edit display window in which a processing pattern outside a processable area is displayed;

FIG. 46 is a photographic illustration of the edit display window in which a continuous-shift of an arched line is chosen;

FIG. 47 is a photographic illustration of the edit display window in which an intermittent-shift of an arched line is chosen;

FIG. 48 is a table of settable parameters for combinations of profile types and shift types;

FIG. 49 is a photographic illustration of the edit display window in which a three-dimensional cutting pattern is displayed in two dimensions;

FIG. 50 is a photographic illustration of the edit display window in which a transparent work is displayed;

FIG. 51 is a photographic illustration of the edit display window in which a plurality of cutting patterns combined in a X-Y plane is displayed for three-dimensional processing; and

FIG. 52 is a photographic illustration of the edit display window in which a plurality of cutting patterns combined in a Z-direction is displayed for three-dimensional processing.

### DETAILED DESCRIPTION OF THE PREFERRED EMBODIMENTS

In the specification, the term “processing” as used herein shall include mean and refer to printing or marking operation and cutting operation. The term “processing pattern” as used herein shall mean and refer to a printing or marking pattern and a cutting pattern. The term “subject pattern” as used herein shall include mean and refer to a pattern subject to printing or marking and cutting and is described as a subject pattern or a cut pattern.

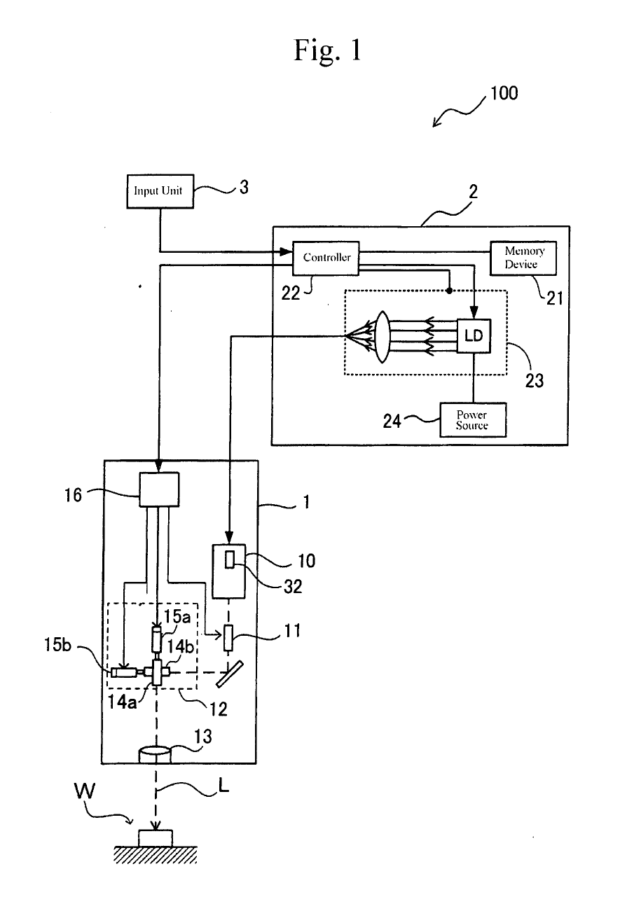

Referring to the accompanying drawings in detail, and in particular, to FIG. 1 showing a laser processing system 100 in accordance with an embodiment of the present invention, the laser processing system 100 comprises a laser output unit 1, a laser control with 2 and an input unit 3. Contrast to typical laser processing systems for processing a work by scanning the work with a two-dimensional pattern by a laser beam, the laser processing system 100 has a three-dimensional scanning unit for scanning a work in three dimensions by a laser beam controlling a focus position of a laser beam L in a three-dimensional space according to a three-dimensional processing pattern so as to scan a work in a three-dimensional pattern with the laser beam.

The input unit 3 is connected to the laser control unit 2 and sends information to the laser control unit 2 entered by a user therethrough so as to generate job control data for the laser processing system 100. For instance, information about operating conditions and a processing pattern are entered as setting data for the laser processing system 100 and sent to the laser control unit 2 tough the input unit 3. The input unit 3 is known in various forms including a keyboard, a touch panel and a mouse and may take any known form. In order to check up on setting data entered through the input unit 3 and a state of the laser control unit 2, a display unit (not shown) be separately provided.

The laser output unit 1 for moving a laser beam L in three dimensions to scan a work with a three-dimensional pattern by the laser beam L includes a laser oscillator schematically shown by reference numeral 10 for exciting a laser medium 32 and causing it to emit induced emission light as a laser beam L, a beam expander 11 for varying a spot size of the laser beam L, a scanning device 12 for moving the laser beam L in two dimensions, a scanner drive circuit 16 for driving the scanning device 12, and a focusing lens 13 for focusing the laser beam L on a work W. An fθ lens is used for the focusing lens 13. The expander 11 is used as a Z-axis scanner for varying a focal distance of the laser beam L so as thereby to vary a spot size of the laser beam L on the work W. The scanning device 12 is a two-dimensional or X-Y scanner for moving a spot of the laser beam L in both X-axis and Y-axis in a plane perpendicular to an optical axis of the focusing lens 13. The expander 11 and the scanning device 12 form the three-dimensional scanning unit. The scanner drive circuit 52 drives the expander 11 and the scanning device 12 with control signals provided by the laser control unit 2.

The laser control unit 2 for controlling the laser output unit 1 comprises at least a memory device 21, a controller 22, a laser excitation device 23 and a power source 24. The memory device 21 stores data including setting data and control data entered via the input unit 3 and sent to the controller 22 in a semiconductor memory such as a ROM or a RAM thereof. The controller 22 comprises a micro-processor and controls the laser excitation device 23 and the laser output unit 1. The controller 22 generates scan signals and sends them to the scanner drive circuit 16 for moving the laser beam L in three dimensions. The controller 22 further generates a power control signal and sends it to the laser excitation unit 23 for controlling intensity of the laser beam L.

The laser excitation device 23 is supplied with a constant voltage from a constant voltage power source 24 and generates excitation light according to an intensity signal from the controller 22. The excitation light is supplied to the laser oscillator 10 of the laser output unit 1 though an optical fiber cable. The intensity signal is a pulse wide modulation (PWM) signal for modulating the excitation light in the form of a train of excitation light impulses and controls the intensity of excitation light, and hence the intensity of the laser beam L (laser power) generated by the laser oscillator 10, according to a frequency and a duty ratio of the pulse signal.

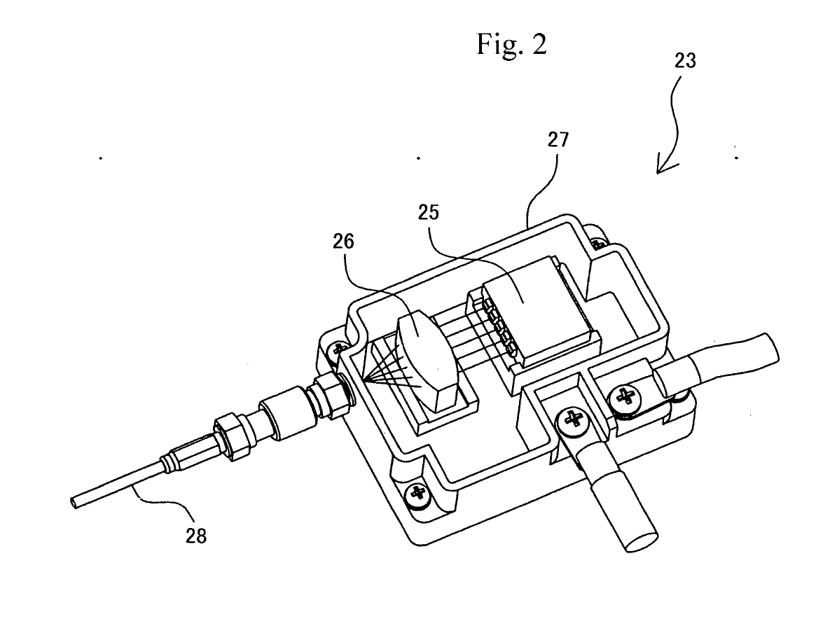

Referring to FIG. 2 showing the laser excitation device 23 in detail by way of example, the laser excitation device 23 comprises a laser excitation light source 25 and a focusing lens system (schematically depicted by a single lens) 26 which are optically aligned and fixedly installed in a casing 27. This casing 27, which is made of a metal having good thermal condition such as brass, effectively releases heat generated by the laser excitation light source 25. The laser excitation light source 25 comprises a plurality of semiconductor laser diodes arranged in a straight row. Laser beams emanating from the respective laser diodes are focused on an incident end of an optical fiber cable 28 by the focusing lens system 26 and guided as an excitation beam to the laser oscillator 10 through the optical fiber cable 28. The optical fiber cable 28 is optically connected to the laser medium 32 of the laser oscillator 10, directly or through a coupling fiber rod (not shown).

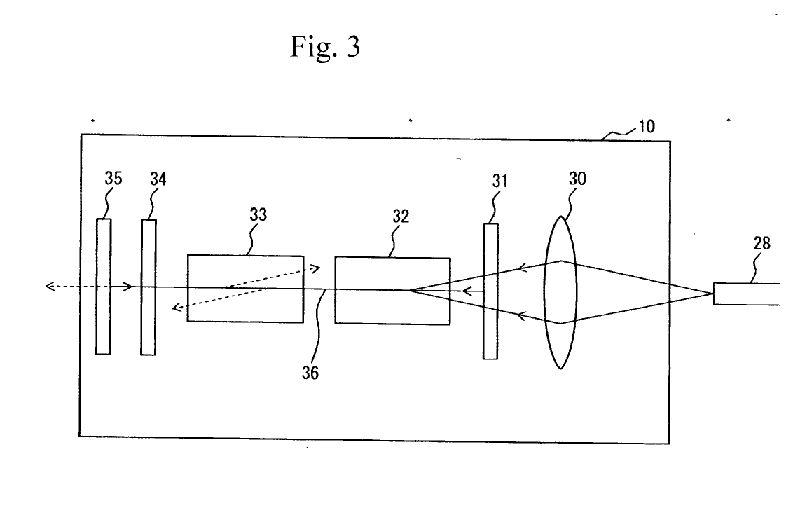

Referring to FIG. 3 showing the laser oscillator 10 in detail by way of example, the laser oscillator 10 is a device for generating a laser beam by radiating excitation light against the laser medium 32 and amplifying induced emission light trough a resonator.

The excitation light is guided into the laser oscillator 10 through the optical fiber cable 28 from the laser excitation device 23. The laser oscillator 10 comprises, in addition to the laser medium 32, a focusing lens 30, an entrance mirror 31, a Q-switching cell 33, an aperture stop 34 and an output mirror 35 all of which are aligned in an optical axis of a resonator (which comprises the entrance minor 31 and the output mirror 35) in this order. The focusing lens 30 focuses excitation light guided by the optical fiber cable 28 inside the laser medium 32. The entrance mirror 31 comprises a half mirror for permitting light incident thereupon from a side of the focusing lens 30 to pass therethrough and totally reflecting light incident thereupon from a side of the laser medium 32. The output mirror 35 comprises a half mirror for reflecting a major part of light incident thereupon and permitting the remaining part to pass therethrough. The excitation light passing through the entrance mirror 31 is focused inside the laser medium 32 and emanates as induced emission light from the laser medium 32. The induced emission light from the laser medium 32 is amplified through multiple reflections caused by the resonator comprising the entrance mirror 31 and the output mirror 35. The aperture stop 34 blocks induced emission light out of the resonator optical axis 36. At the same time, the Q-switching cell 33, which comprises an acoustic optical modulator (AOM), deflects the induced emission light so as to cause it to travel out of the resonator optical axis 36 when it is activated. Accordingly, when the Q-switching cell 33 is activated, the laser oscillation is interrupted.

The laser medium 32 used in this embodiment nay comprise an Nd:YVO₄solid state laser medium (a laser medium of yttrium.vandate doped with neodymium ions). In this case, light having a wavelength of 809 nm which is a central wavelength of absorption spectra of the Nd:YVO₄is used as the excitation light. Laser mediums available for the laser medium 32 include YAG, LiSrF, LiCaF, YLF, NAB, KNP, LNP, NYAB, NPP and GGG each of which is doped with a rare earth metal. It is practicable to convert a wavelength of the laser beam by the use of a combination of such a solid state laser medium and a wavelength conversion element. Otherwise, it is practicable to use a wavelength conversion element performing wavelength conversion only without using a solid state laser medium, i.e. a resonator for laser oscillation. In this case, wavelength conversion is made for a laser beam generated by the semiconductor laser medium. Available examples of the wavelength conversion element include KTP(KTiPO₄); non-linear organic optical media and non-linear inorganic optical media such as KN(KNbO₃), KAP(KASpO₄), BBO and LBO; and bulk type polarizing-inverting elements such as LiNbO₃ (PPLN: Periodically Polled Lithium Niobate), LiTaO₃ and the like. Further, it is allowed to use a laser excitation semiconductor laser of an up-conversion type using a fluoride fiber doped with a rare earth such as Ho, Er, Tm, Sm Nd and the like. The laser medium 32 is not bounded by a solid state laser medium and may comprise a gas such as a CO₂ gas, an He—Ne gas, an Ar gas, and a N gas, etc. The gas filled in the laser oscillator 10 provided with electrodes therein is excited according to an intensity signal to generate a laser beam.

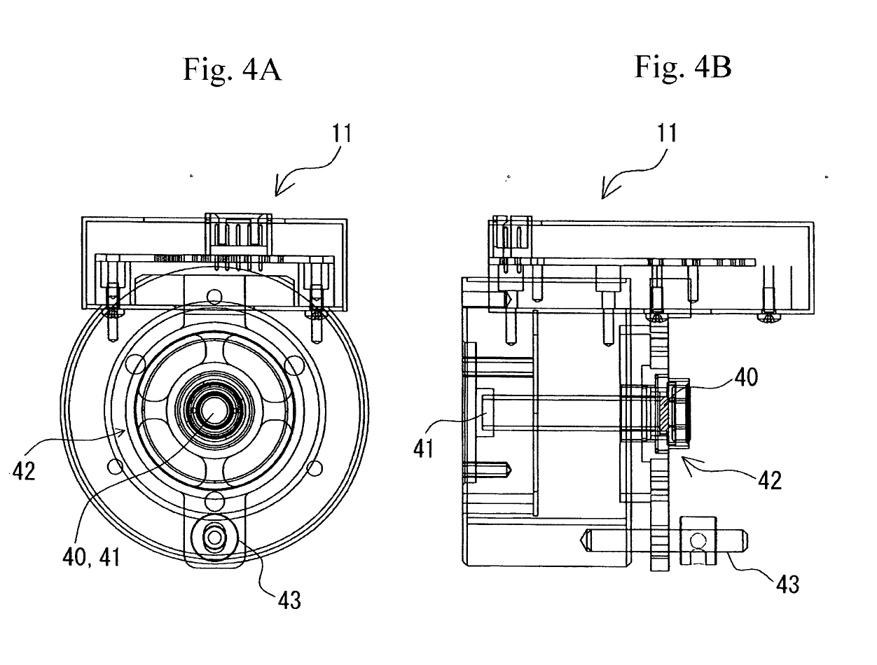

As shown in FIGS. 4A and 4B, the beam expander 11 has a lens system comprising a movable lens 40 and a stationary lens 41. The movable lens 40 is held by a lens drive mechanism 42 guided for axial slide movement by a guide bar 43. The lens drive mechanism 42 includes electromagnetic drive means (not shown) for moving the movable lens 40 to an axial position according to a drive signal provided by the scanner drive circuit 16 (see FIG. 1). The beam expander 11 varies a beam size of the laser beam L generated by the laser oscillator 10 by varying a relative axial distance between the movable lens 40 and the stationary lens 41. The laser beam L adjusted in beam size by the beam expander 11 is focused by the focusing lens 13 so as to form a sharp spot on a plane at different distances according to beam sizes. Accordingly, the beam expander 11 serves as a Z-axis scanner for scanning an object in a direction of the optical axis of the focusing lens 13 (Z-axis) by varying the relative axial distance between the movable lens 40 and the stationary lens 41. In this instance, the beam expander 11 may comprise lenses 40 and 41 either one or both of which are movable. In place of using the beam expander 11, it is of course allowed to use any variable focal-length lens system for focusing a fixed beam size of laser beam at different distances.

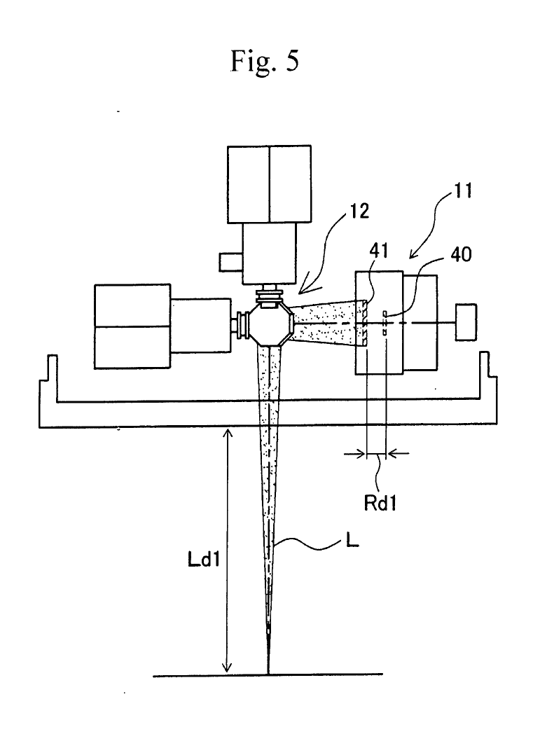

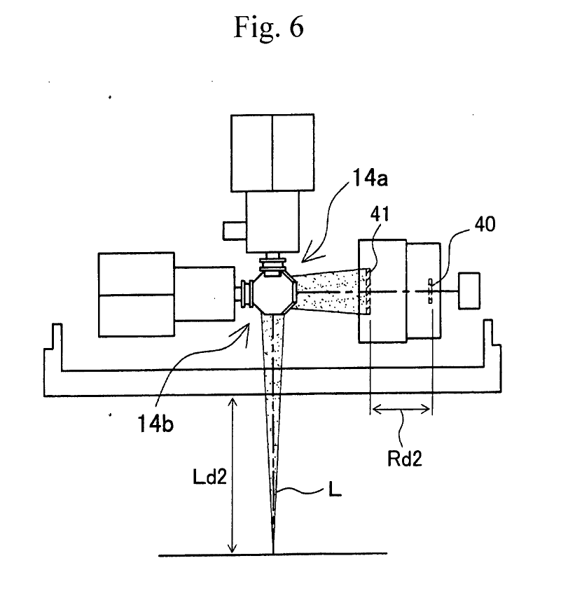

FIGS. 5 and 6 show the Z-axis scanning device comprising the device 12 and the beam expander 11 which forms a part of the three-dimensional scaling unit. In the figures, the focusing lens 13 is left out for simplicity. As shown in FIG. 5, when the beam expander 11 increases a beam size of the laser beam L by decreasing a relative axial distance between the movable lens 40 and the stationary lens 41 as indicated by a reference Rd1, the laser beam L is focused at a distance as indicated by a reference Ld1. On the other hand, as shown in FIG. 6, when the beam expander 11 increases a beam size of the laser beam L by increasing a longer axial distance between the movable lens 40 and the stationary lens 41 as indicated by a reference Rd2, the laser beam L is focused at a shorter axial distance as indicated by a reference Ld2. In other words, the beam expander 11 can vary a work distance of the laser beam L (a distance between the laser processing system 100 and a work to be processed by the laser processing system 100) by varying the a relative axial distance between the movable lens 40 and the stationary lens 41.

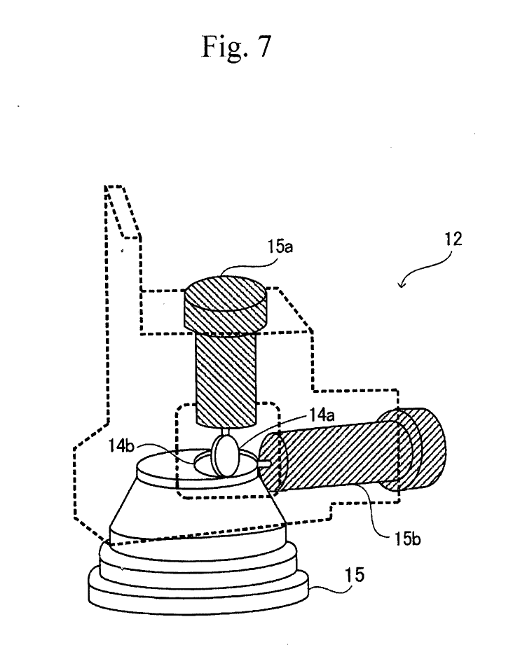

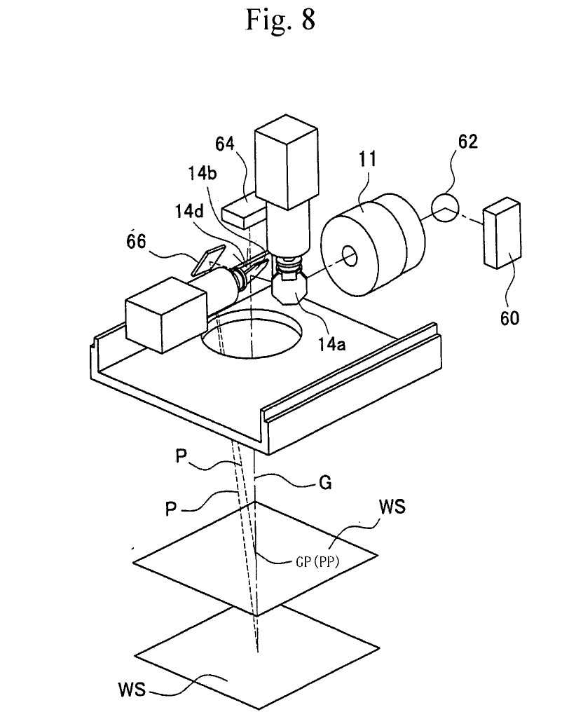

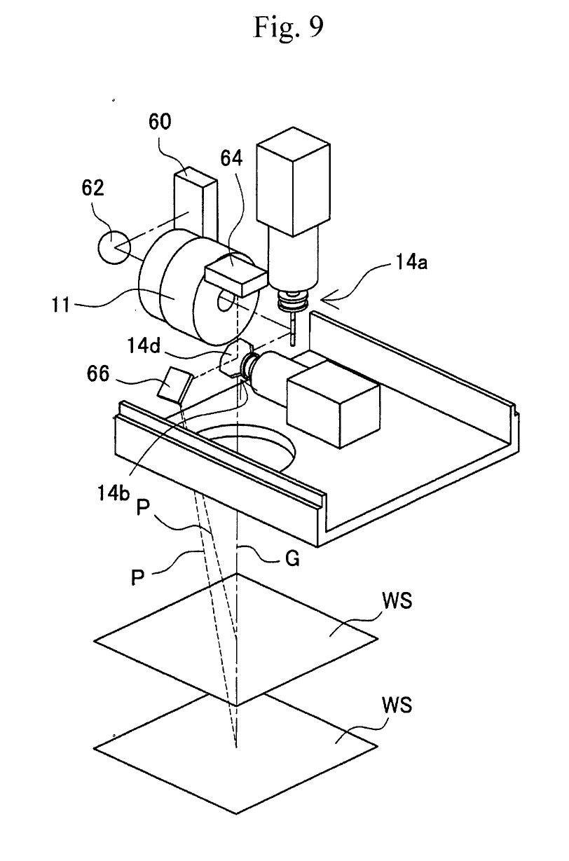

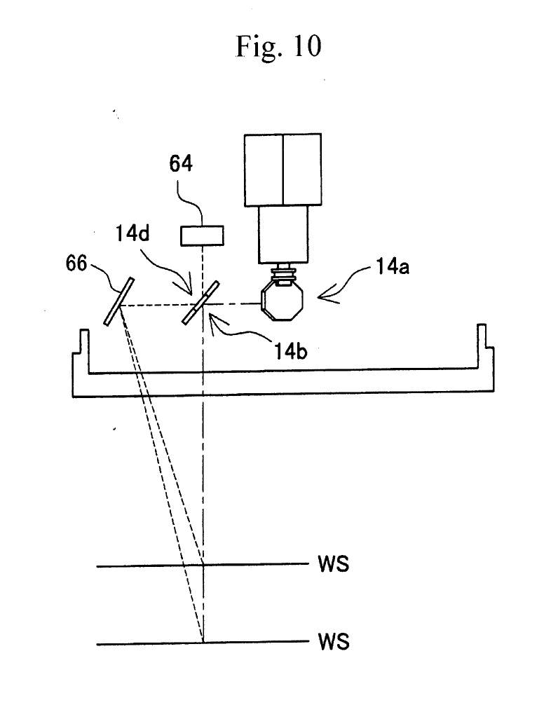

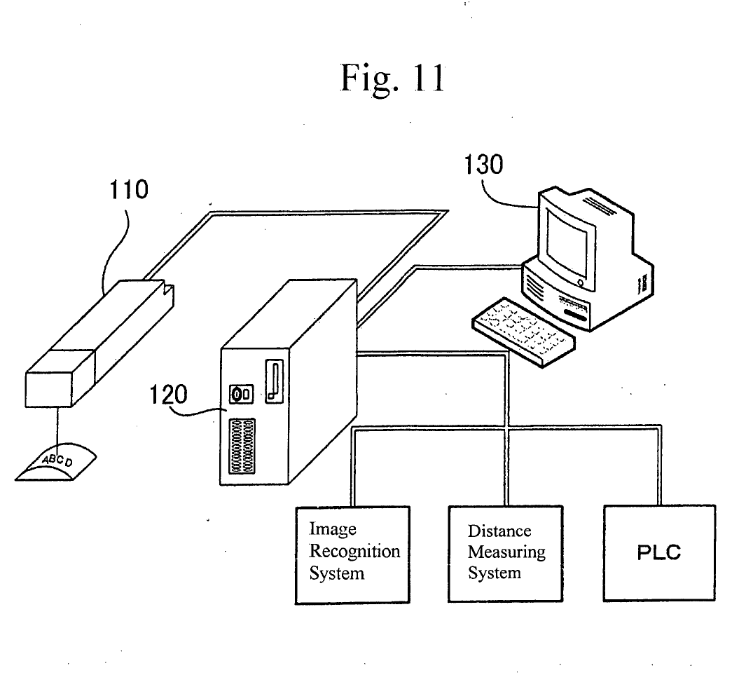

FIG. 7 shows the X-Y or two-dimensional scanning device 12 which forms a part of the three-dimensional scanning unit. The X-Y scanning device 12 comprises an X-axis scanner comprising a galvanometer 15a and a galvanometer mirror 14a mounted on a shaft of the galvanometer 15a and a Y-axis scanner comprising a galvanometer 15b and a galvanometer mirror 14b mounted on a shaft of the galvanometer 15a. The galvanometers 15a and 15b may comprise stepping motors to rotate their shaft by angles within the bounds of noninterference between the galvanometer mirrors 14a and 14b. The laser beam L entering the scanning device 12 is deflected in two dimensions in a X-Y plane (work surface) perpendicular to the optical axis of the focusing lens 13 (Z-axis) by the X-Y scanning device 12 comprising the X-axis scanner and the Y-axis scanner. The three-dimensional scanning unit is accompanied by a distance pointer for projecting a specific color of visual pointer onto a work W for indicating a working distance (which refers a distance between a work and the focusing lens 13) as shown in FIGS. 8 to 10.

Referring to FIGS. 8 to 10, the distance pointer comprises a guide light source 60, a guide mirror 62, a pointer light source 64, a pointer mirror 14d formed on the reverse side of the galvanometer mirror 14b of the Y-axis scanner and a distance control mirror 66 disposed off the Z-axis (the optical axis of the focusing lens 13). Guide light G emanating from the guide light source 60 is reflected by the guide mirror 62 disposed in a path of the laser beam L and then travels along the laser beam path so as to project a visible guide pattern GP onto a work W. At the same time, visible pointer light P emanating from the pointer light source 64 is reflected by the pointer mirror 14d and subsequently by the distance control mirror 66 and then travels towards the work W so as to project a visible point pattern PP. The pointer light P reflected by the distance control mirror 66 travels at an angle with a path of the guide light G in a plane including the Z-axis (the optical axis of the focusing lens 13) so as to intersect with the guide light G at a point in the Z-axis direction which is defined by the angle of travel of the guide light G. The distance between the intersection point and the focusing lens 13 is referred to as a pointing distance. In consequence, a distance pointer, which comprises a composite pattern of the visible guide pattern GP and the visible point point PP, changes in pattern according to working distances and forms a predetermined characteristic pattern only when the working distance and the pointing distance coincide with each other.

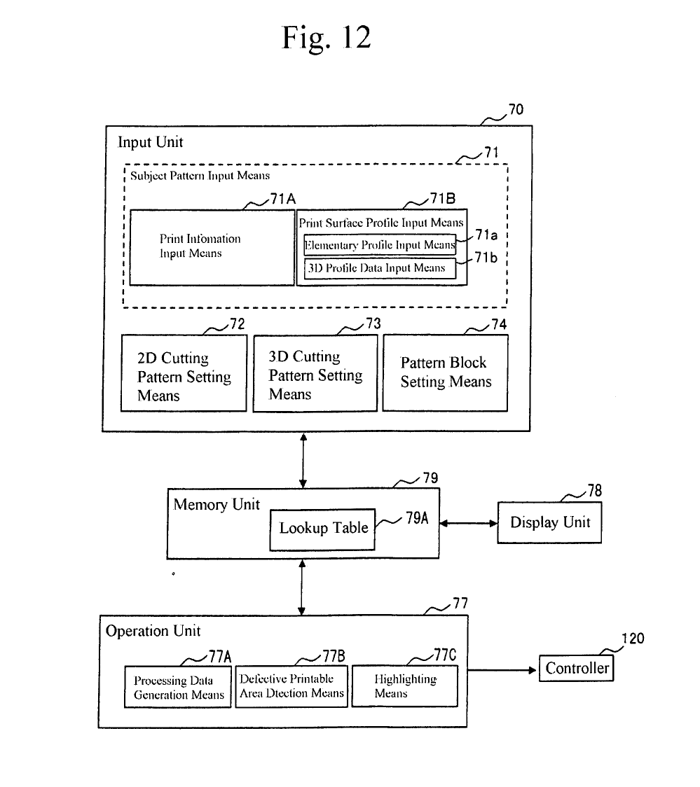

FIG. 12 shows the laser processing system applied as a laser marking system. The laser marking system comprises at last a laser processing head 110, a controller 120 and a processing data setting device 130 which correspond to the laser output unit 1, the laser control unit 2 and the input unit 3, respectively, shown in FIG. 1. The laser processing head 110 radiates a laser beam L to a work W. The controller 120 controls the laser processing head 110. The processing data setting device 130 is a user terminal through which users provide processing data representing processing conditions and transmits the processing data to the controller 120 for achieving desired processing by the laser processing head 110. The processing data setting device 130 is adapted to generate processing data representing a processing pattern according to which the controller 120 controls the three-dimensional scanning unit installed in the laser processing head 110 so as thereby to perform processing with the three-dimensional pattern. The pattern processing performed by the laser processing system includes not only marking of a planer pattern such as a character string, a barcode and a graphic on a three-dimensional work surface but also cutting for modifying a three-dimensional shape of a work W such as drilling and/or cutting a comparatively thin work for shaping it. The laser processing system may be applied to machining a metal mold because of high precision of the laser processing. The controller 120 may be accompanied by various external equipments such as an image recognition device 120a comprising an image sensor for confirming a type and a position of a work W conveyed in a processing line, a distance measuring device 120b for acquiring information about a distance between a work and the laser processing head 110, and a programmable logic controller (PLC) 120c for controlling the system according to a given sequence logic, as well as a photo diode (PD) sensor for detecting a work W passing therethrough and other sensors (not shown). These external equipments are connected to the controller 120 for data communication.

FIG. 12 illustrates the architecture of the processing data setting device 130 for setting laser processing data for perform desired processing in block diagram. The processing data setting system 130 comprises an input unit 70 through which users input processing conditions as setting data, an operation unit 77 for generating processing data by carrying out an operation on the basis of the setting data, a data display unit 78 for displaying the setting data and the processing data and a memory unit 78 for storage of the setting data and the processing data. The input unit 70 has subject pattern input means 71 through which processing conditions are entered, 2D cutting pattern input means 72 through which a two-dimensional cutting pattern is entered as a processing condition, 3D cutting pattern input means 73 through which a three-dimensional cutting pattern is entered as a processing condition, and pattern block setting means 74 for editing and managing these processing conditions.

The subject pattern input means 71 comprises print information input means 71A through which information about a two-dimensional subject pattern such as a character string, a graphic and the like as print conditions and printing surface profile input means 71B rough which information about a three-dimensional profile of a printing surface. The printing surface profile input means 71B comprises elementary profile specifying means 71a for specifying a printing surface profile among prepared elementary profiles and three-dimensional surface profile data input means 71b for externally inputting printing surface data representing a three-dimensional profile. The pattern block setting means 74 is used to allot pattern blocks to a plurality of subject patterns and cuing patterns in a working area and to specify one of the pattern blocks as an object of editing. The operation unit 77 comprises processing data generating means 77A for generating processing data according to processing condition entered through the input unit 70 and outputting it to the controller 120, defective area detecting means 77B for detecting a defective area of a work which is unprocessable or only defectively processable with the laser beam L, and highlighting means 77C for displaying and highlighting a defective processable area distinctly from a processable area. The processing data setting device 130 may comprise a dedicated hardware and is, however, realized by a general-purpose computer with a processing data setting program installed therein in this embodiment.

The following description is directed to a sequence of generating a processing pattern according to user-entered setting data by executing a processing data setting program according to an embodiment. The processing data setting program is designed to run in two edit modes, namely a two-dimensional edit mode (2D edit mode) for editing a two-dimensional processing pattern in which a processing pattern is displayed only in two dimensions and a three-dimensional edit mode (3D edit mode) for editing a three-dimensional processing pattern in which a processing pattern is displayed alternately in two dimensions and in three dimensions.

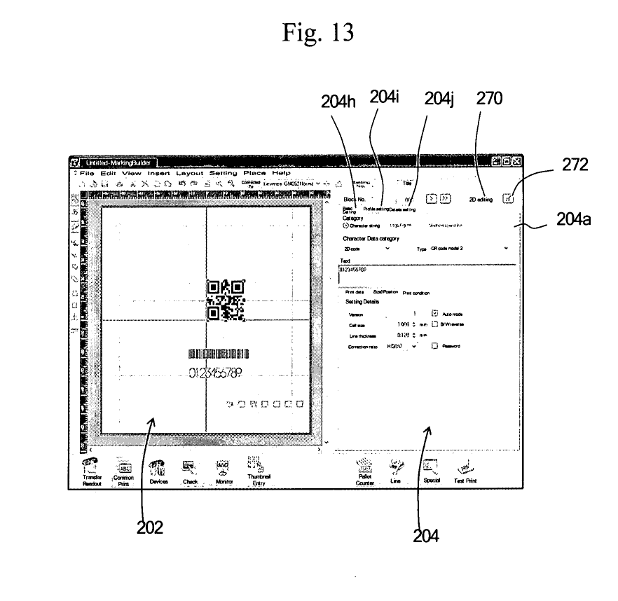

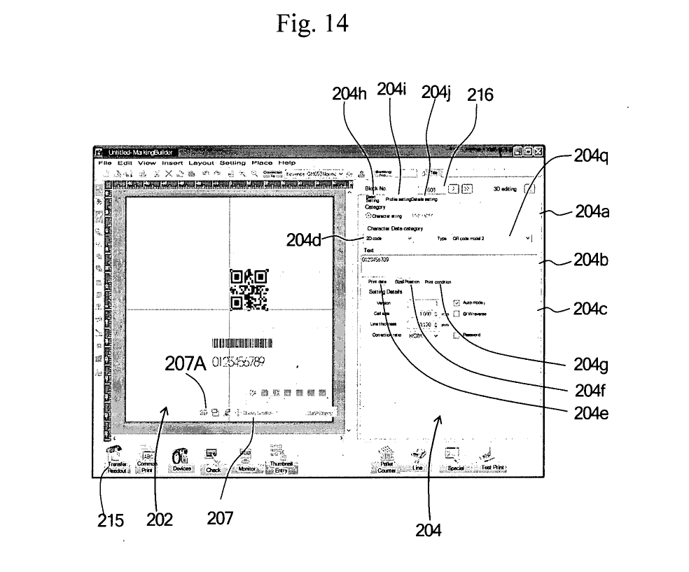

FIGS. 13 and 14 illustrate user interface windows of the processing data setting program. In this embodiment, the user interface window basically comprises a display window 202 at the left-hand side thereof and a pattern setting dialog box 204 at the right-hand side thereof (which are integrally referred to a display window). In the individual edit display windows, dialog boxes, buttons, tab keys and the like of the edit display window and the dialog box may be appropriately changed in location, shape, size, color and/or pattern. When the processing data setting program is activated, a display window in the 2D edit mode (which is hereinafter referred to as a 2D edit mode display window) shown in FIG. 13 is chosen by default. When clicking a mode switching button 272 provided at an upper right corner of the 2D edit mode display window, a display window in the 3D edit mode (which is hereinafter referred to as a 3D edit mode display window) shown in FIG. 14 appears in place of the 2D edit mode display window. The edit display window is altered between the 2D edit mode and the 3D edit mode by clicking the mode switching button 272. An edit mode currently chosen is indicated in a current mode box 270 adjacent to the mode switching button 272 in the pattern setting dialog box 204. These 2D edit mode display window and 3D edit mode display window have almost similar appearances. The default edit mode which is the 2D edit mode in this embodiment enables users who are unfamiliar with editing of three-dimensional processing data to easily edit a three-dimensional processing pattern. Further, similar appearances of the 2D edit mode display window and the 3D edit mode display window enable uses to perform editing operation of two-dimensional processing data just like editing operation of three-dimensional processing data. Because it is possible in the 3D edit mode to complete three-dimensional processing data by specifying a two-dimensional subject pattern in the 3D edit mode display window similar to the 2D edit mode display window and thereafter adding information about a three-dimensional shape to the two-dimensional subject pattern, the user interface enables users who have experienced only in editing of two-dimensional processing data to set up three-dimensional processing data in a simple way.

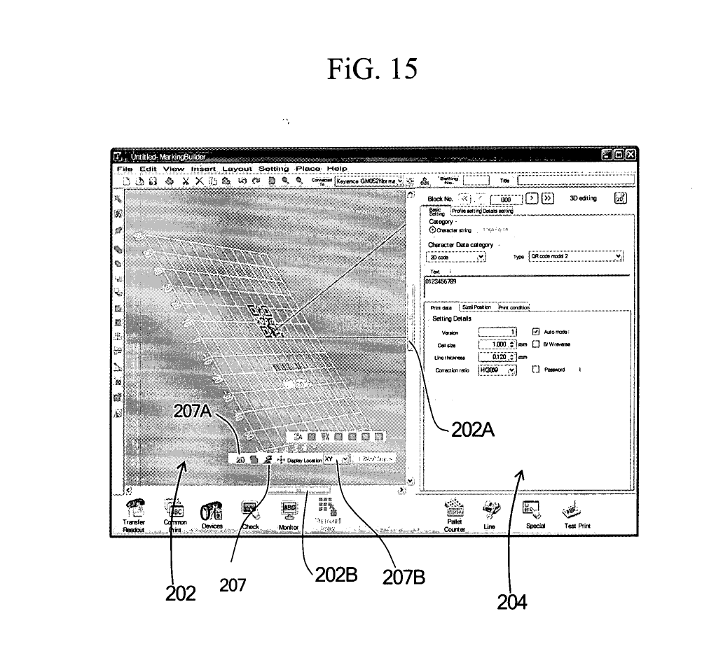

Referring to FIG. 15 illustrating a 3D edit mode display window in which a three-dimensional representation of a processing pattern is displayed. The type of representation is altered from a three-dimensional representation mode (which is hereinafter referred to as a 2D representation mode) to a two-dimensional representation mode (which is hereinafter referred to as a 2D representation mode) and vice versa by clicking a representation switch button 207A in a floating tool bar 207 displayed in the display window 202. An icon or indication “2D” or “3D” appears on the representation switch button 207A to indicate a representation mode into which the display can be altered. The processing pattern can be moved vertically and horizontally in the display window 202 by moving scroll bars 202A and 202B, respectively. The three-dimensional representation of the processing pattern can be displayed as if the processing pattern is viewed from different viewpoints. Specifically, when clicking a move/rotation switching button (not shown) in the floating tool bar 207, the scroll bars 202A and 202B are functionally altered from a move mode to a rotation mode or vice versa. Specifically, when clicking the move/rotation switching button to chose the rotation mode, the three-dimensional representation is linearly tuned by 360° centered on a horizontal rotational axis (not shown) passing through an origin of coordinates in the display window 202 by moving the scroll bar 202A up or down. On the other hand, the three-dimensional representation is linearly tuned by 360° centered on a vertical rotational axis (not shown) passing through the center of coordinates in the display window 202 by moving the scroll bar 202A right or left. Further, the three-dimensional representation can be displayed in an X-Y orthogonal coordinate plane, a Y-Z orthogonal coordinate plane or a Z-X orthogonal coordinate plane as an orthogonal oriented view in the coordinate plane by choosing a desired coordinate plane in a pull-down menu listing view planes of X-Y, Y-Z and Z-X which appears when opening a view position box 207B provided in the floating tool bar 207.

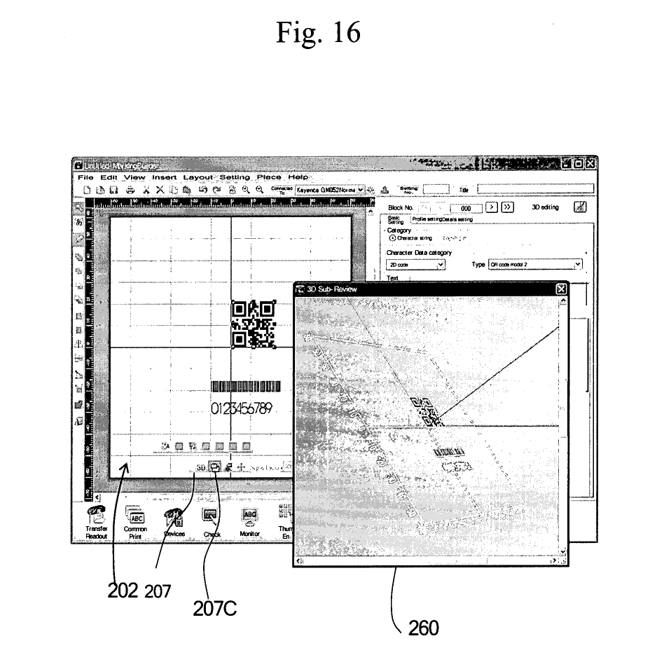

Referring to FIG. 16 illustrating the 3D edit mode display window in which a 3D viewer window is additionally opened. In case where it is desired to display an object in three dimensions while the display window 202 displays the object in two dimensions, the processing data setting program provides a 3D viewer window 260. When clicking a 3D viewer open button 207C in the floating tool bar 207 in the edit display window 202, a 3D viewer window 260 is additionally opened over the display window 202. In this instance, while the display window 202 displays an object in three dimensions, the 3D viewer open button 207C grays out and is disabled.

Referring back to FIGS. 14 and 15, the processing data setting program provides the pattern setting dialog box 204 functioning as the print information input means 71A through which processing conditions and other information are specified to determine a processing pattern. The pattern setting dialog box 204 includes and a dialog tab box having a basic setting dialog tab 204h, a profile setting dialog tab 204i, and a details setting dialog tab 204j which are selectively enabled by users. When enabling the basic setting dialog tab 204h in the pattern setting dialog box 204 as shown in FIG. 14, there are provided a processing category box 204a, a text box 204b, a print category menu box 204d, a print type menu box 204q and a details dialog box 204c. The details dialog box 204c includes a printing data dialog tab 204e, a size/position setting dialog tab 204f and a printing condition setting dialog tab 204g which are selectively enabled to specify details by users. The printing data dialog tab 204e is enabled by default when the basic setting dialog tab 204h is enabled. The processing category box 204a displays options, such as “character string” for specifying a true font character string or a symbolized character string as a subject pattern and “logo/graphic” for specifying any two-dimensional figure, with accompanied by check buttons, respectively. Either category is exclusively chosen by clicking the check button of the category. In this instance, when choosing the 2D edit mode display window as shown in FIG. 13, the processing category box 204a displays “3D machine operation” as an additional option as well as “character string” and “logo/graphic.” The category of “3D machine operation” is provided in order to specify a two-dimensional cutting (processing) pattern. Therefore, when choosing the 3D edit mode display window as shown in FIG. 14, the indication of “3D machine operation” is cleared. When enabling the print category menu box 204d, a pull-down menu appears to list print categories such as “character,” “barcode,” “two-dimensional code” arid “RSS-CC (Reduced Space Symbology-Composite Code).” Further, when enabling the print type menu box 204q subsequent to specification of a print category, a pull-down menu appears to list available print types according to the specified print category. For example, the pull-down menu shows available font styles when specifying the category of “character,” barcodes such as CODE39, ITF, 2 of 5, NW7, JAN, Code 28 and the like when specifying the category of “barcode,” codes such as QR code, a micro QR code, Data Matrix and the like when specifying the category of “two-dimensional code,” and codes such as RSS-14, CC-A, RSS Stacked, RSS Stacked CCA, RSS Limited, RSS Limited CC-A and the like when specifying the category of “RSS-CC.” The text box 204b permits users to enter characters. An entered character string is adopted as it is when having specified the category of “character” in the print category menu box 204d On the other hand, when having specified the symbol category, i.e. “barcode,” “two-dimensional code” or “RSS-CC” in the print category menu box 204d, a subject pattern is formed in the shape of a symbol by encoding the character string according to a format of the specified symbol category.

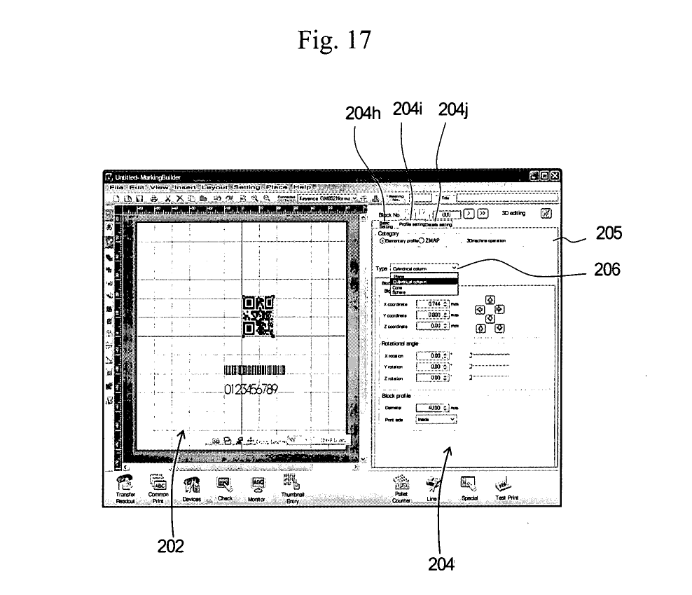

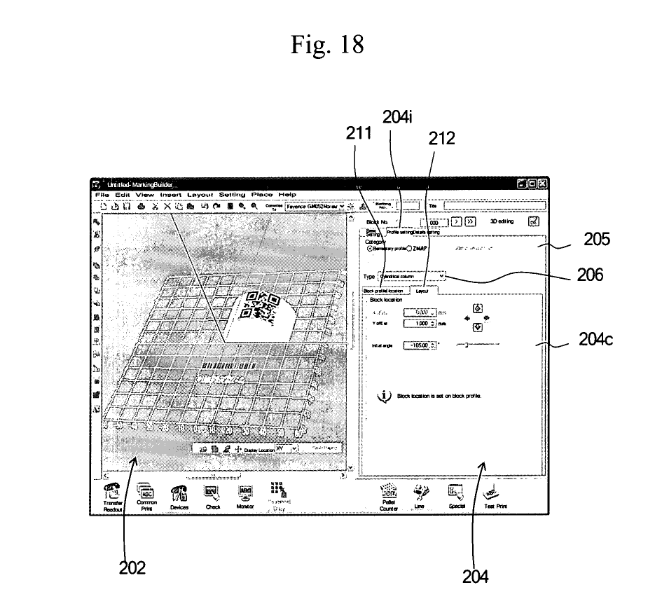

Referring to FIG. 17, the processing data setting program provides the profile setting dialog box 204 functioning as the printing surface profile input means 71B through which a three-dimensional profile of a printing surface of a work is specified. The two-dimensional subject pattern specified through the printing information input means 71A is transformed according to the specified three-dimensional printing surface profile. The profile setting dialog box 204 opens when the profile setting dialog tab 204i is enabled. The profile setting dialog box 204 permits users to specify a printing surface profile in two different ways, in other words, functions as both elementary profile specifying means 71a and three-dimensional profile data input means 71b shown in FIG. 12. The profile setting dialog box 204 includes a dialog tab box having a basic setting dialog tab 204h, a profile setting dialog tab 204i and a details setting dialog tab 204j which are selectively enabled by users. When enabling the basic setting dialog tab 204h in the profile setting dialog box 204, there are provided a profile category box 205, a profile type menu box 206 and a details dialog box in the profile setting dialog box 204. The details dialog box includes a block profile/location setting dialog tab 211 and a layout setting dialog tab 212 (see FIG. 18) which are selectively enabled to specify parameters by users. The profile category box 205 displays options, such as “elementary profile” for specifying one of elementary profiles, “ZMAP” and “3D machine operation,” with accompanied by check buttons, respectively. Either category is exclusively chosen by clicking the check button of the category. When choosing “elementary profile,” the profile setting dialog box 204 functions as the elementary profile specifying means 71a for specifying a printing surface profile among prepared elementary profiles. On the other hand, when choosing “ZMAP,” the profile setting dialog box 204 functions as the three-dimensional profile data input means 71b for externally inputting printing surface data to set a three-dimensional surface profile. In this instance, the term “ZMAP file” means a three-dimensional profile data file prepared in a file format in which information about a Z-coordinate is parallelized to each X- and Y-coordinates.

FIGS. 17 and 18 illustrates a profile setting dialog box 204 functioning as the elementary profile specifying means 71a. When enabling the profile setting dialog box 204 by enabling the profile setting dialog tab 204i, there are provided a profile category box 205, a profile type menu box 206 and a details dialog box in the profile setting dialog box 204. The details dialog box includes a block profile/location setting dialog tab 211 and a layout setting dialog tab 212 which are selectively enabled to specify parameters by users. The profile category box 205 displays options, such as “elementary profile,” “ZMAP” and “3D machine operation,” with accompanied by check buttons, respectively. When enabling the profile type menu box 206 after check the button of “elementary profile” in the profile category box 205, a pull-down menu appears to show available elementary profile types such as “plane,” “cylindrical column”, “sphere” and “cone” for specification by users. Parameters are specified in the block profile/location setting dialog tab 211 and the layout setting dialog tab 212 according to an elementary profile type specified in the profile category box 205. A three-dimensional block defying a three-dimensional printing surface profile is determined. The print subject pattern entered through the printing information input means 71A can be displayed over the three-dimensional block. Specifically, when specifying, for example, “cylindrical column” as an elementary profile as shown in FIG. 17, the block profile/location setting dialog tab 211 prompts the user to specify parameters, i.e. X, Y and Z coordinates for specifying a location of the cylindrical column, rotational angles centered on X, Y and Z axes, respectively, for specifying an orientation of the cylindrical column, a diameter for specifying a size of the cylindrical column and a side for specifying a printing surface, namely an outer convex surface or an inner or concave surface. Further, in order to specify a pasting position in which the subject pattern is pasted the three-dimensional block, the layout setting dialog tab 212 is enabled. The layout setting dialog tab 212 prompts the user to speedy parameters, i.e. a Y-axis offset for specifying a displacement of a center axis of the cylindrical column from the Y-axis and a start angle for specifying a center angle.

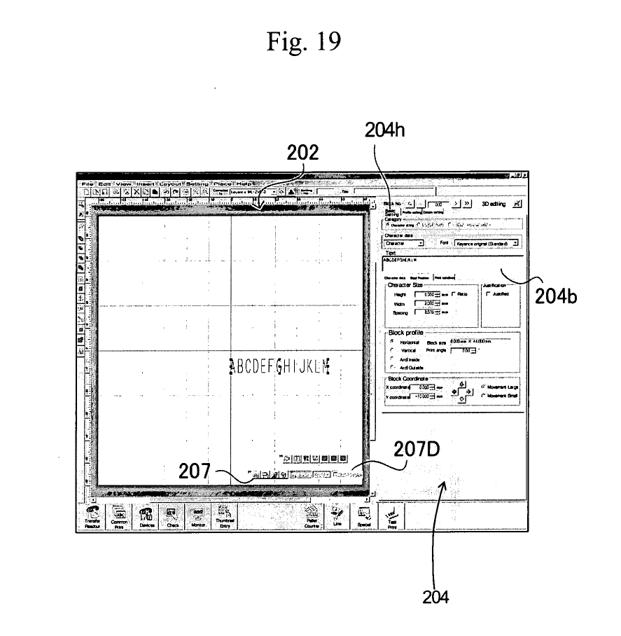

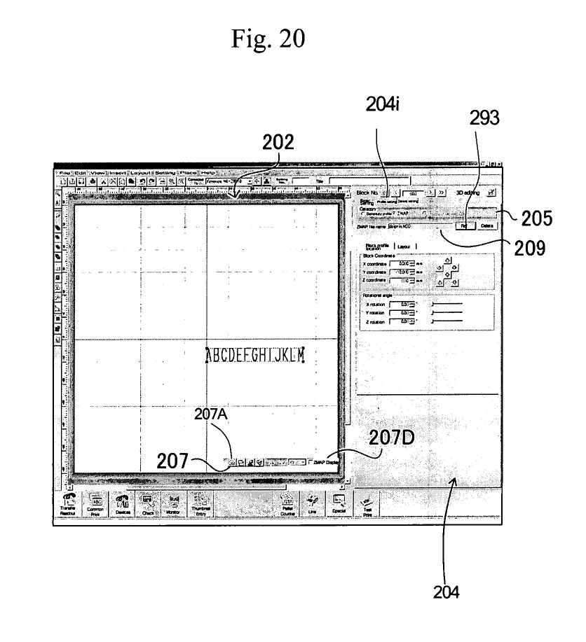

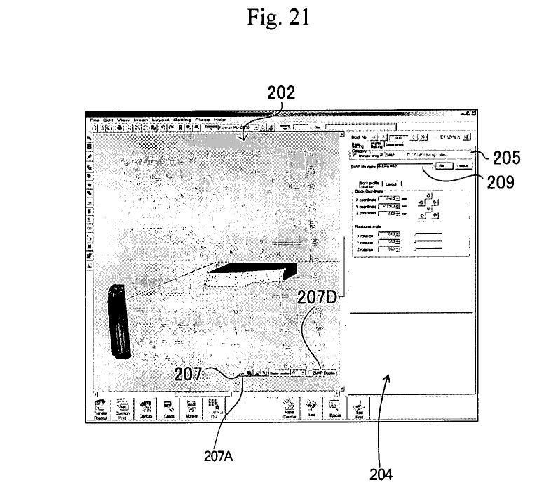

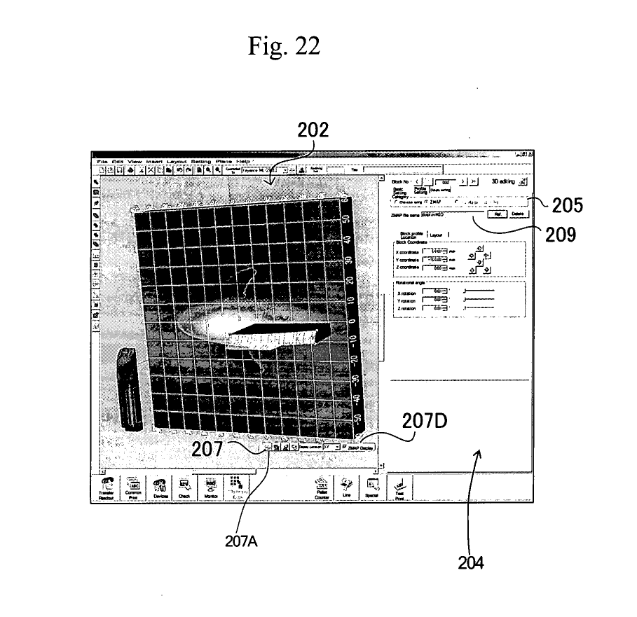

FIGS. 19 to 21 illustrates a three-dimensional profile setting dialog box 204 functioning as the three-dimensional profile data input means 71b for setting a three-dimensional profile of printing surface from an external data file of three-dimensional profile created by the use of, for example, a computer assisted design system. The three-dimensional profile setting dialog box 204 includes at least a basic setting dialog tab 204h shown in FIG. 19 and a profile setting dialog tab 204i shown in FIG. 20. As shown in FIG. 19, when enabling the basic setting dialog tab 204h by default, there is provided a text box 204b and other boxes. After entering a text, for example, “ABCDEFGHIJKLM” in the text box 204b, the profile setting dialog tab 204i is enabled as shown in FIG. 20. When enabling the profile setting dialog tab 204i, there is provided a profile category box 205 which displays options, such as “elementary profile” for specifying one of elementary profiles, “ZMAP” and “3D machine operation.” When specifying the category of ZMAP in the profile category box 205, a ZMAP file box 209 appears to prompt the user to enter an available ZMAP file name therein. When clicking a reference button 293, a ZMAP file having by the file name is definitely specified and read in to display the as three-dimensional data defined by the ZMAP file and representing a three-dimensional profile of a printing surface with the character string “ABCDEFGHIJKLM” pasted thereto in the display window 202 as shown in FIG. 20. In this state, when clicking the representation switch button 207A in the floating tool bar 207, the display window 202 is altered from representation of the 2D representation mode to the 3D representation mode to display the three-dimensional work profile with the character string “ABCDEFGHIJKLM” pasted thereto in three dimensions as town in FIG. 21. Coincidentally with specifying a ZMAP file in the ZMAP file box 209, a check box of ZMAP display tool 207D in the floating tool bar 207 is enabled. When marking the check box 207D in the profile setting dialog box 204 shown in FIG. 21, the three-dimensional printing surface profile with the character string “ABCDEFGHIJKLM” is displayed by superposition on a work represented by the ZMAP file as shown in FIG. 22. This feature enables users to visually confirm a general appearance of printing.

In the case of the laser marking system, the processing data generating means 77A generates processing data representing a three-dimensional subject pattern (a subject pattern in this case) according to information about a printing surface profile and information about printing specified by users. That is, the laser processing data contains control data for X-axis, Y-axis and Z-axis scanners provided according to the three-dimensional subject pattern specified by the user. Pasting of a two-dimensional subject pattern to a ZMAP file defining a work profile is achieved so that the two-dimensional subject pattern in an orthogonal projection on a three-dimensional printing surface (FIGS. 21 and 22) is recaptured in a right representation of the printing information when viewing the printing surface in a specific direction, e.g. squarely, in other words, so that, even when a two-dimensional representation of the subject pattern “ABCDEFGHIJKL” displayed in the display window 202 show in FIG. 19 is converted into three-dimensional representation thereof as show in FIGS. 21 and 22, the subject pattern in plane is identical with that shown in FIG. 20.

In this case, information about height i.e. a Z-coordinate, of a position having an X-Y coordinate defined by the ZMAP data which corresponds to an X-Y coordinate of the subject pattern is added as tertiary information to the subject pattern information. In this way, the X-axis scanner and the Y-axis scanner are driven according to the subject pattern information, and the Z-axis scanner is driven according to the printing surface profile information. Because information of the ZMAP file is referred with respect to height only and the plane information are used just as they are, it is easy to perform data processing for converting of the printing information so as to change a subject pattern from a two-dimensional representation to a three-dimensional representation. In consequence, this manner is advantageous to reducing load on the data processing and speeding up the data processing and, in particular, in terms of processing capacity and processing speed. In addition in the application where a subject pattern is observed for confirmation in one specific direction, the manner offers an advantage in reproducing a correct pattern. For example, even in the case where a symbol such as a barcode is printed on a curved work surface, it is improbable to cause an error in reading a narrow space width due to deformation of the narrow space at an end portion of the barcode as long as reading the barcode in a right direction. Further, in the case where an optical character reader is used to scan characters, precise scanning is realized due to reduced deformation of the characters.

On the other hand, in the case where conversion to three-dimensional processing data is performed by the use of an elementary profile, a two-dimensional subject pattern representing the printing information is pasted to a development of the elementary profile in plan. That is, two-dimensional representation of a subject pattern is changed from as shown in FIG. 16 to as shown in FIG. 17 in the display window 202. This way of conversion is advantageous to those cases where the direction of confirmatory observation is not fixed. For instance, in the case of printing a character string such as a date of manufacture and/or a serial number on a product, it is assured to make easy-to-read print. In this instance, the X-axis scanner, the Y-axis scanner and the Z-axis scanner are driven according to two-dimensional information about a subject pattern and a printing surface profile. Even in cases of using an elementary profile for information about a printing surface profile, it is permitted to generate a three-dimensional subject pattern in the same manner as using a ZMAP file. In other words, it is permitted to drive the X-axis scanner and the Y-axis scanner according to two-dimensional printing information and the Z-axis scanner according to printing surface profile information so that the subject pattern in an orthogonal projection on a three-dimensional printing surface is recaptured in a right representation of the printing information when viewing the printing surface in a direction of Z-axis.

The defective area detecting means 77B detects a defective printing area which is printable but only defectively in terms of printing quality due to laser beam angles or blocking of laser beam and an unprintable area which is unprintable. When angle of a laser beam from the laser processing head 110 incident upon a printing surface becomes smaller, printing quality deteriorates or printing becomes impossible. Therefore, the defective area detecting means 77B is adapted to detect an area of a printing surface on which a laser beam impinges at angles within a predetermined range of angle as a defective printing area. Further, printing is impossible if printing surface areas are bidden from a laser beam. The defective area detecting means 77B is adapted to detect such a hidden surface area as an unprintable area.

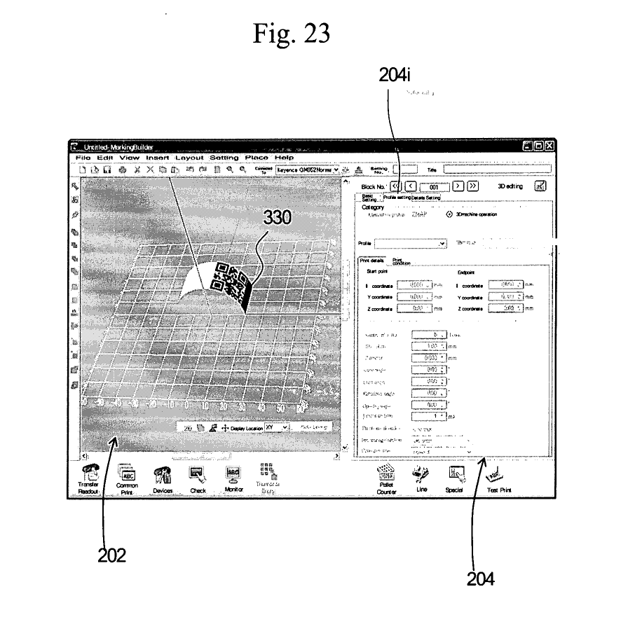

FIG. 23 illustrates a three-dimensional profile setting dialog box 204 functioning as the highlighting means 77C for highlighting a defective printing area detected by the defective area detection means 77B visually distinctly, more specifically differently in color or intensity, from the remaining printing area. As shown in FIG. 23, a side area of a semicylindrical column 330, namely a defective printing area, upon which a laser beam impinges at smaller angles is colored or brightened differently from the remaining area by the highlighting means 77C.

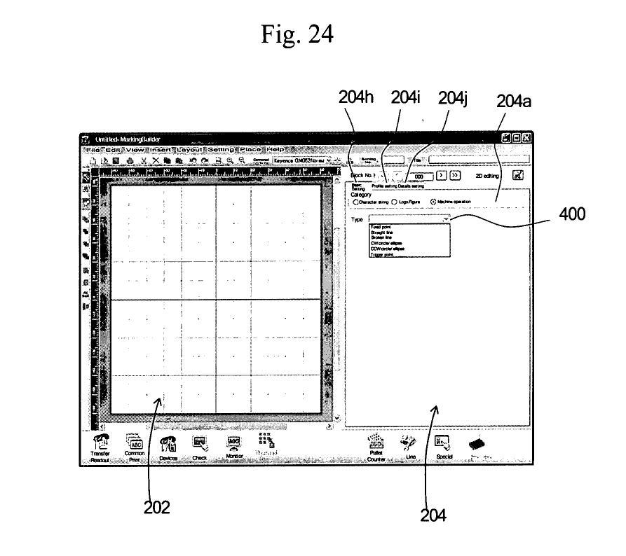

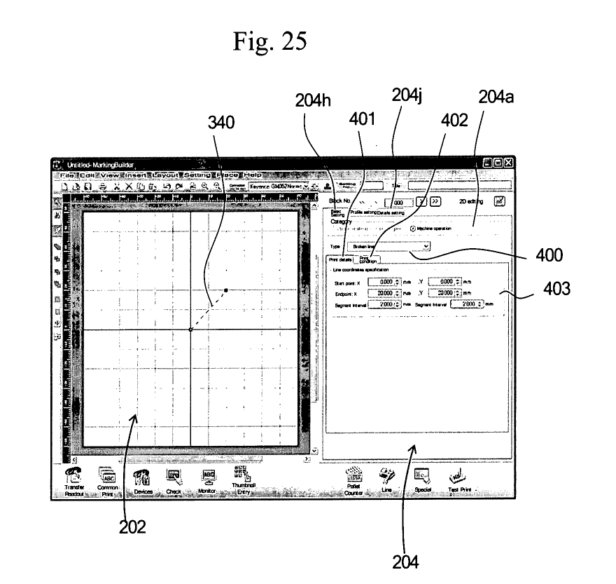

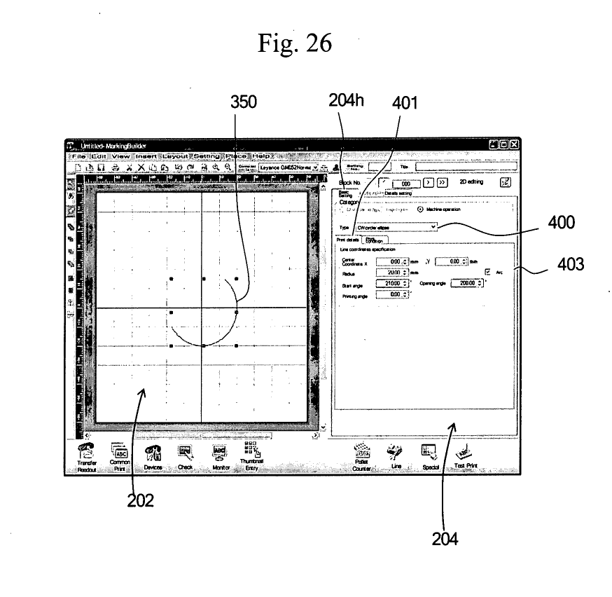

FIG. 24 illustrates a profile setting dialog box 204 in the 2D edit mode in which the basic setting dialog tab 204h is enabled. In the basic setting dialog tab 204h, there is provided a processing category box 204a displaying options, namely “character string,” “logo/graphic” and “3D machine operation.” When choosing “3D machine operation” in the processing category box 204a, while the display window 202 is change into the 2D edit mode display window which functions as the 2D cutting pattern input means 72 for setting a two-dimensional cutting pattern, the basic setting dialog tab 204h opens a pull-down menu 400 listing available cutting patters such as a “fixed point,” a “straight line,” a “broken line,” a “clockwise (CW) circle/ellipse,” a “counterclockwise (CCW) circle/ellipse,” a “circular arc,” a “centered point” and the like so as to prompt the user to specify one of term. When specifying a cutting pattern in the pull-down menu 400, while the display window 202 displays a cutting pattern corresponding to the specified pattern, the basic setting dialog tab 204h provides a processing details dialog tab 401 and a processing condition dialog tab 402 which are selectively enabled. As shown in FIG. 25, when specifying the “broken line” as a cutting pattern and enabling the processing details dialog tab 401, while the display window 202 displays a broken line 340, the cutting details 401 provides boxes for specifying coordinates of opposite ends of broken line, a length of broken line and a separation between broken line segments in a details setting box 403. Further, as shown in FIG. 26, when specifying the “clockwise circle/ellipse” the “counterclockwise circle/ellipse” or the “circular arc” in the pull-down menu 400 and enabling the processing details dialog tab 401, while the display window 202 displays a specified line pattern such as a counterclockwise circle/ellipse 350, the processing details dialog tab 401 provides boxes for specifying X and Y coordinates of a center of circle, radiuses in X and Y axes, a start angle, an angle of opening and a printing angle in a details set box 403. Details to be specified include X and Y coordinates of a center of a circle and radiuses in X and Y axes of an ellipse, and a start angle of an end point of an arc, an angle of opening of an arc and a printing angle indicating an angle of rotation of an arc, in addition to X and Y coordinates of a center of circle and a radius of a circle.

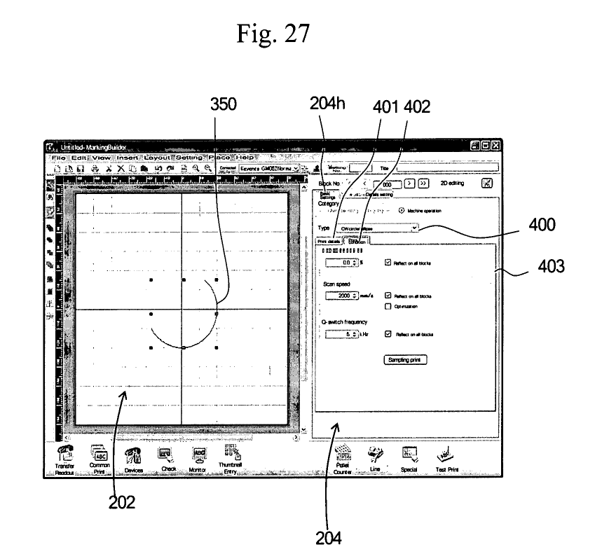

FIG. 27 shows the processing condition dialog tab 402 which is enabled to specifying printing conditions. The processing condition dialog tab 402 provides a cutting power box for specifying laser power for cutting, a scan speed box for specifying a cutting speed and a Q-switching frequency box for specifying a Q-switching frequency in a details setting box 403. Cutting with a two-dimensional pattern, which is carried out in order to form a cut line or a cut surface in an object in a Z-axis direction, is performed by adjusting a depth of cutting by providing laser energy greater than printing. The laser energy can be adjusted by controlling laser power and/or scan speed.

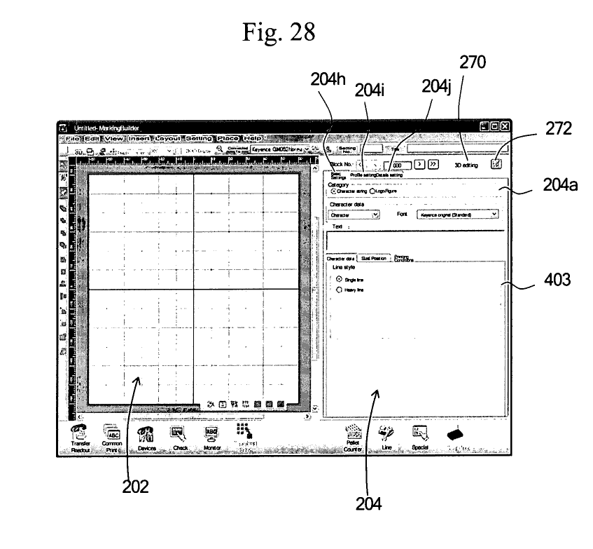

FIG. 28 illustrates a profile setting dialog box 204 in the 3D edit mode in which the basic setting dialog tab 204h is enabled by clicking the mode switching button 272 when the profile setting dialog box 204 is in the 3D edit mode shown in FIG. 24. As shown in FIG. 28, in the basic setting dialog tab 204h, there is provided a processing category box 204a displaying “character string” and “logo/graphic” only. The option of “3D machine operation” is not displayed for preventing users setting a two dimensional cutting pattern.

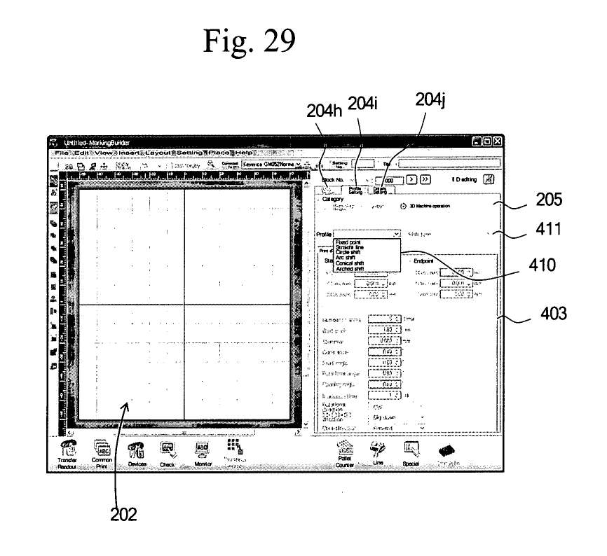

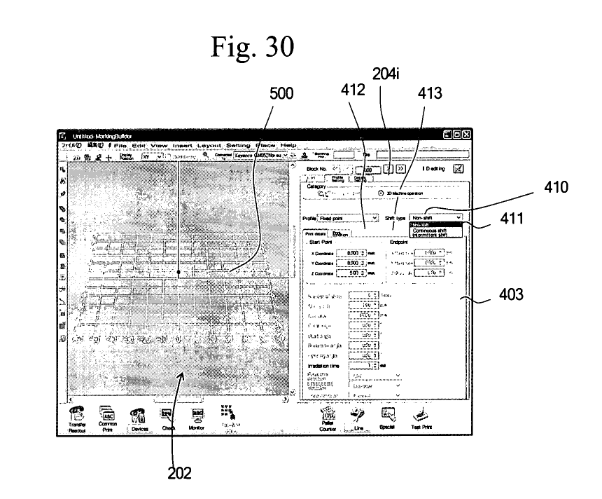

FIG. 29 illustrates a three-dimensional cutting pattern setting dialog box in which a profile setting dialog tab 204i functioning as the 3D cutting pattern input means 73 for entering a three-dimensional cutting pattern as a cutting condition is enabled when intending to specify the “3D machine operation” for three-dimensional cutting. The profile setting dialog tab 204i provides a processing category box 205 displaying options, namely “elementary profile,” “ZMAP” and “3D machine operation” with accompanied by check buttons, respectively. However, when an editing object is directed to a subject pattern block, in other words, when the “character string” or the “logo/graphic” is specified in the processing category box 204a in the basic setting dialog tab 204h, the processing category box 205 puts the “3D machine operation” unavailable by graying out it. On the other hand, when an editing object is directed to one other than subject pattern blocks, the processing category box 205 puts the “3D machine operation” availably by graying out both “elementary profile” and “ZMAP.” A three-dimensional cutting pattern is a pattern for forming a cut line or a cut surface having a width in a Z-axis direction greater than a cutting width of a laser beam L in an object. The three-dimensional cutting pattern includes a pattern in a flat plane in parallel to the Z-axis. Cutting with the three-dimensional cutting pattern is performed by repeating cutting with a two-dimensional cutting pattern in a specific manner. Specifically, the two-dimensional cutting pattern and the cutting manner are specified as “profile type” and “shift type,” respectively, by users. As shown in FIG. 29, the profile setting dialog tab 204i provides a profile type menu box s and a shift type menu box 411, and besides, a processing details dialog tab 412 and a processing condition dialog tab 413 (see FIG. 30) which are selectively enabled. The profile type menu box 410 displays options, namely a “fixed point” pattern, a “straight line” pattern, a “circle shift” pattern, a “circular arc shift” pattern, a “conical circle shift” pattern and an “arched shift” pattern. The profile type of “fixed point” pattern offers cutting pattern formation by repeatedly shifting a point specified in an X-Y plane by the user in a Z-axis direction. The profile type of “straight line” pattern, “circle shift” pattern or “circular arc shift” pattern offers cutting pattern formation by repeatedly shifting a straight line, a circle or a circular arc, respectively, specified in an X-Y plane by the user in a Z-axis direction. The profile type of “conical circle shift” pattern offers cutting pattern formation by repeatedly expanding and shifting a circle specified in an X-Y plane by the user in a Z-axis direction. The profile type of “arched shift” pattern offers cutting pattern formation by repeatedly shifting a semicircle (an arch as used herein is referred to a cemicircular arc) specified in a plane to Y-axis by the user in a Z-axis direction. In this instance, in any cases, the pattern specified by users should be a unicursal diagram having no connecting point that is drawn with a single stroke.

Further, the shift type menu box 411 displays options, namely “non-shift,” “continuous shift” and “intermittent shift” (see FIG. 30). When specifying one of the shift types in the shift type menu box 411, the processing details dialog tab 412 is enabled to display parameter boxes to define the specified cutting pattern. Parameters to be specified are different according to the available profile types and the available shift types. When spying “non-shift” in the shift type menu box 411, a two-dimensional cutting pattern is depicted by drawing a figure according to a specified profile type without shining the figure in the Z-axis direction. When specifying “continuous shift” in the shift type menu box 411, the three-dimensional cutting pattern is depicted by, while making a continuous line drawing m an X-Y plane, continuously shifting the line drawing in the Z-axis direction so as to draw a pattern according to a specified profile type with a single stroke. That is, the three-dimensional cutting pattern is drawn by coincidentally carrying out a two-dimensional scan in the X-Y plane and a scan in the Z-axis direction. In consequence, the three-dimensional cutting pattern is not formed in a plane in parallel to an X-Y plane and is always at an angle with the X-Y plane. When specifying “intermittent shift” in the shift type menu box 411, a three-dimensional cutting pattern is drawn by carrying out a two-dimensional scan in the X-Y plane and a scan in the Z-axis direction in synchronism with but not coincidentally with each other and, inconsequence, depicted in the form of an aggregative pattern of a number of two-dimensional subject patterns in parallel to one another. That is, in the case of “intermittent shift,” except for specification of the “arched shift” pattern the three-dimensional pattern is depicted by alternately carrying out a two-dimensional scan in the X-Y plane and a scan in the Z-axis direction so as to build up an aggregation of a number of two-dimensional patterns in parallel to the X-Y plane. By means of performing the “continuous shift” or the “intermittent shift,” it is realized to cut a line or a surface with a width greater in a Z-axis direction than a laser beam width. In this instance, since lines or surfaces that are cut by carrying out “continuous shift” and “intermittent shift” under the same conditions are substantially identical to each other, users are enabled to choose either one of the shift types, i.e. “continuous shift” and “intermittent shift,” according to the quality of a work material, required cutting accuracy and the like.

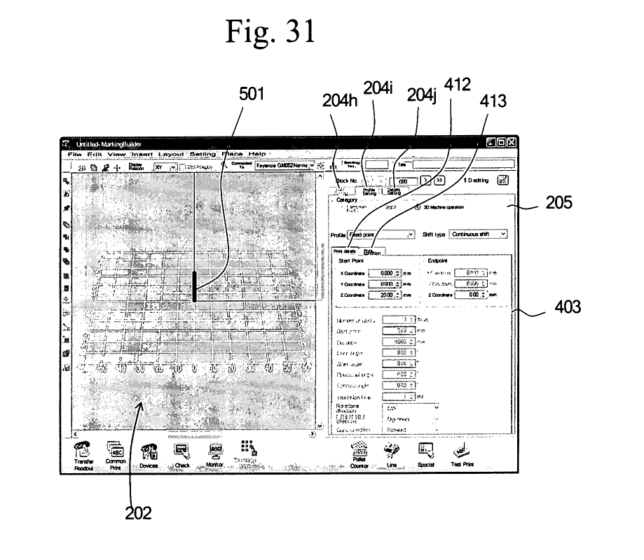

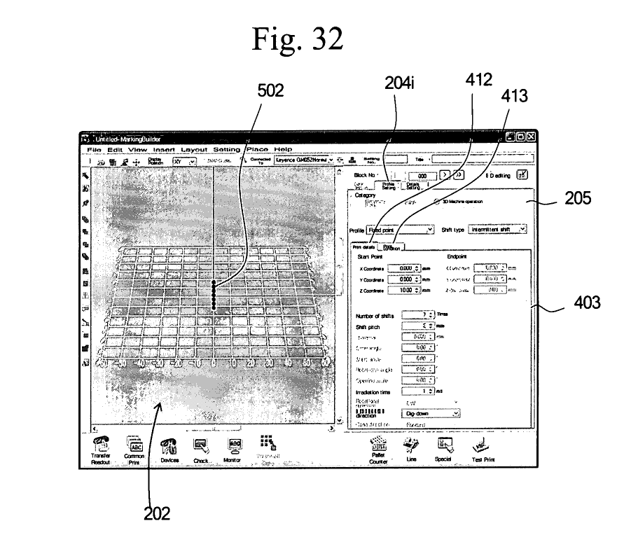

FIGS. 30 to 32 illustrate 3D edit mode display windows when the “fixed point” pattern is specified in the profile type menu box 410 in the profile setting dialog tab 204i. As shown in FIG. 30, when specifying “non-shift” in the shift type menu box 411, the display window 202 displays a cutting pattern 500 in the form of a fixed point in a three-dimensional space. In this case, the processing details dialog tab 412 prompts the user to specify parameters, namely X, Y and Z coordinates of a starting point and an irradiation time of a laser beam against the point. As shown in FIG. 31, when specifying the “continuous shift” in the shift type menu box 411, a cutting pattern 501 which is formed by continuously shifting a fixed point is a straight line extending in parallel to the Z-axis from the fixed point. In this case, the processing details dialog tab 412 prompts the user to specify parameters, namely X, Y and Z coordinates of a starting point and an endpoint. As shown in FIG. 32, when specifying the “intermittent shift” in the shift type menu box 411, a cutting pattern 502 which is formed by intermittently shifting a fixed point comprises a number of points rowed at regular intervals in a straight line in parallel to the Z-axis. In this case, parameters to be specified in the processing details dialog tab 412 are X, Y and Z coordinates of a starting point, a number of points, an interval a laser irradiation time for each point.

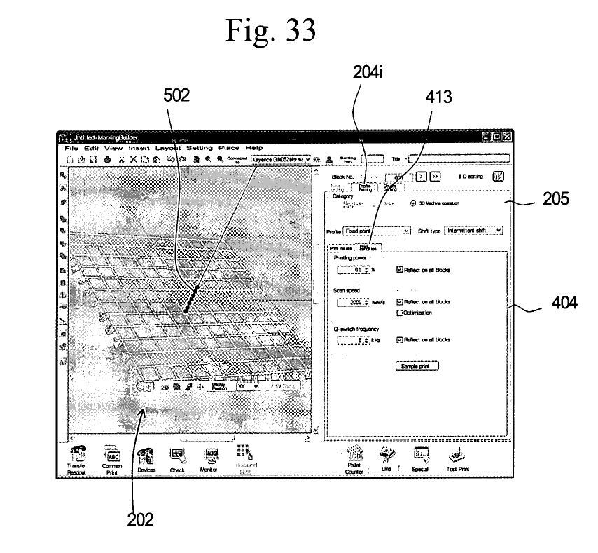

FIG. 33 illustrates a 3D edit mode display window in which the processing condition dialog tab 413 is enabled when the “fixed point” pattern and the “non-feed” are specified in the profile type menu box 410 and the shift type menu box 411, respectively, in the profile setting dialog tab 204i. The processing condition dialog tab 413 has condition boxes for specifying cutting conditions, namely laser beam strength, a three-dimensional scan speed and a Q-switching frequency, respectively. These conditions except for the scan speed are similar to those in the case of setting a two-dimensional cutting pattern. However, by contrast with the two-dimensional cutting pattern setting in which the scan speed is defined by a shift distance of a laser beam per unit of time in an X-Y plane, the three-dimensional cutting pattern setting is different in that the scan speed is defined by a shift distance of a laser beam per unit time in a three-dimensional space including an Z-axis direction. Further, in the case of the two-dimensional cutting pattern setting, a cutting depth in a Z-axis direction is controlled by controlling an energy supply to a point in the X-Y plane according to the specified parameters. By contrast, the three-dimensional cutting pattern setting is not necessitated to do so and performed by specifying parameters so as to optimize cutting accuracy and cutting speed in consideration of a required width of processed line.

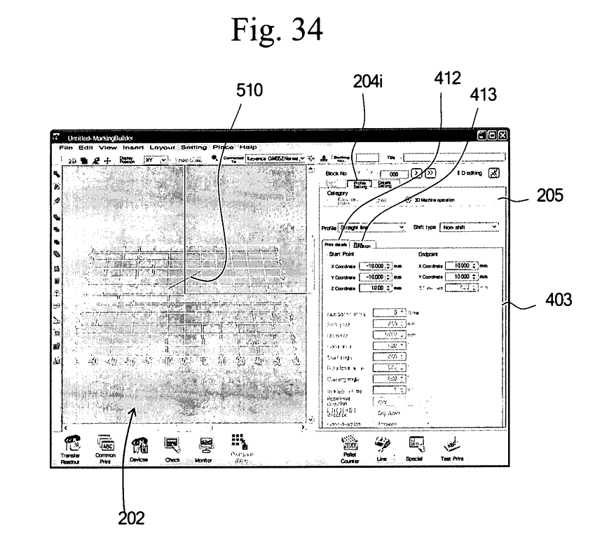

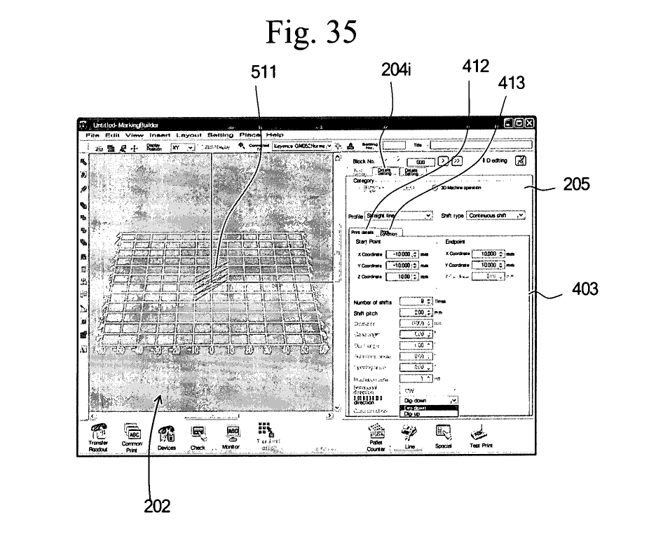

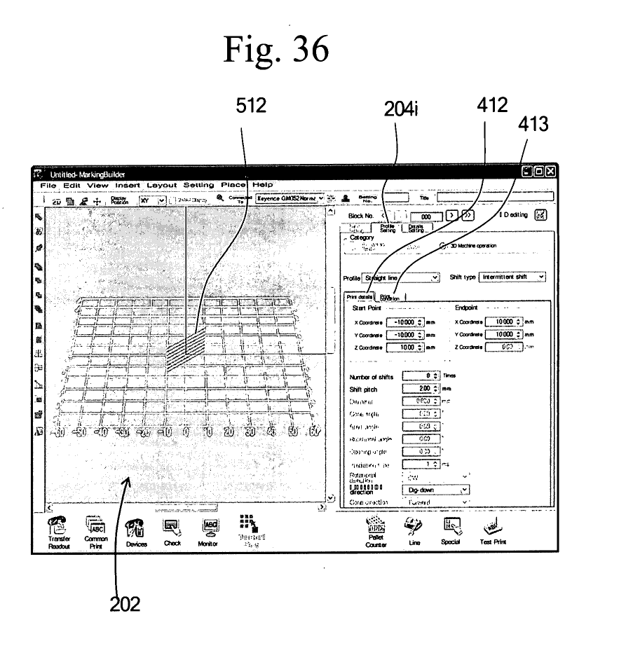

FIGS. 34 to 36 illustrate 3D edit mode display windows when the “straight line” pattern is specified in the profile type menu box 410 in the profile setting dialog tab 204i. As shown in FIG. 34, when specifying the “non-shift” pattern in the shift type menu box 411, the display window 202 displays a cutting pattern 510 in the form of a straight line in parallel to an X-Y plane. Parameters to be specified in the processing details dialog tab 412 are X, Y and Z coordinates of a staring point and an endpoint of a line. As shown in FIG. 35, when specifying the “continuous shift” in the shift type menu box 411, the display window 202 displays a cutting pattern 511 which is a continuous polygonal line comprising a plurality of straight lines each of which is at an angle with an X-Y plane. The cutting pattern is depicted by, while repeatedly making a continuous line drawing in an X-Y plane, continuously shifting the line drawing in the Z-axis direction so as to draw a continuous polygonal line to a specified profile type with a single stroke. A rectangular cut surface in parallel to the Z-axis is obtained through the use of the cutting pattern formed in this way. In tis case, parameters to be specified in the processing details dialog tab 412 are, in addition to those specified upon specification of the “non-shift,” the number of reciprocating shifts, a pitch of shift and a cutting direction. The number of reciprocating shifts is the total number of forward shifts and backward shifts, i.e. the number of straight lines. The pitch of shift is a distance in the Z-axis direction during every shift in the X-Y plane. The cutting direction is a direction in which a laser beam spot travels from a surface of a work into an inside of the work or vice versa. There are two cutting directions, namely a “dig down” direction in which a laser beam spot is shifted from a surface of a work into an inside of the work and a “dig up” direction in which a laser beam spot is shifted from an inside of a work to a surface of the work. The cutting in the “dig up” direction is applied to works which transmits a laser beam. Further, as shown in FIG. 36, when specifying the “intermittent shift” in the shift type menu box 411, the display window 202 displays a cutting pattern 512 comprising an aggregation of a number of straight lines in parallel to an X-Y plane which are arranged at regular pitches in the Z-axis direction. The same parameters specified upon specification of the “continuous shift” are specified when specifying the “intermittent shift.”

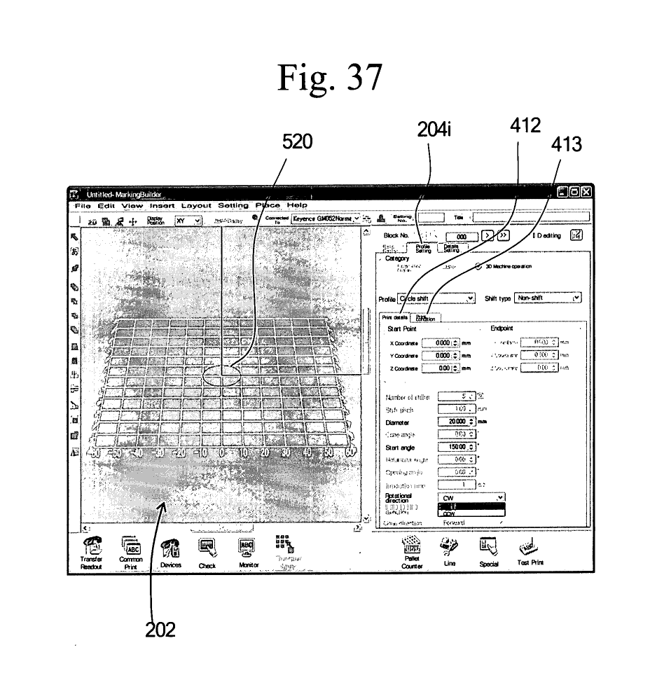

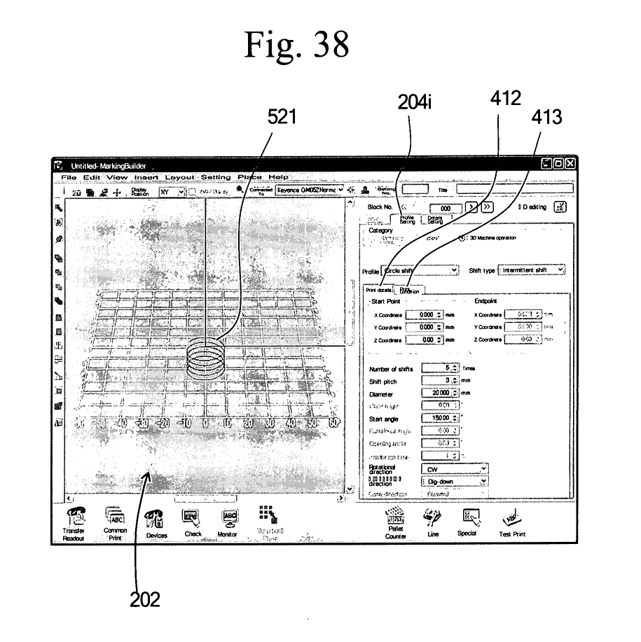

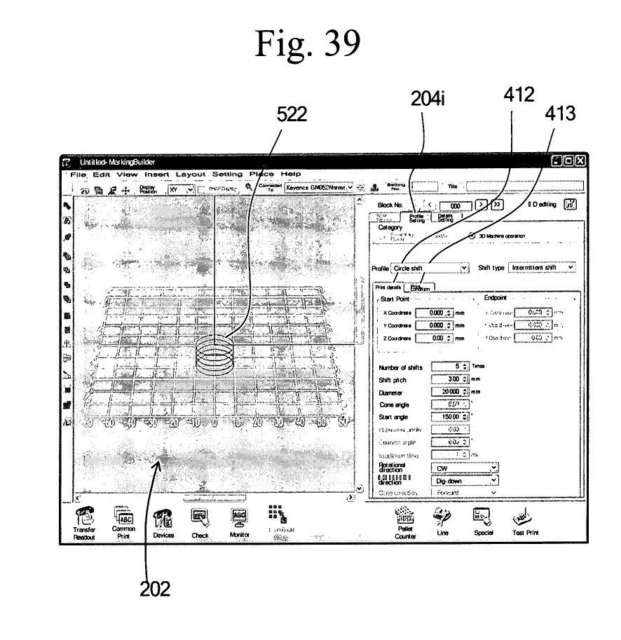

FIGS. 37 to 39 illustrate 3D edit mode display windows when the “circular shift” pattern is specified in the profile type menu box 410 in the profile setting dialog tab 204i. As shown in FIG. 37, hen specifying the “non-shift” in the shift type menu box 411, the display window 202 displays a cutting pattern 520 in the form of a circle in parallel to an X-Y plane. Parameters to be specified in the processing details dialog tab 412 are X, Y and Z coordinates of a center of a circle (start point), a diameter of the circle, a start angle of the circle and a rotational direction. In this instance, the “start angle” is translated as a start point (or endpoint) from which a laser beam starts to draw a circle and is specified as an angle with, for example, the Z-axis. The “rotational angle” is translated as a direction, i.e. a clockwise direction or a counterclockwise direction, in which a laser beam travels to draw a circle. As shown in FIG. 38, when specifying the “continuous shift” in the shift type menu box 411, the display window 202 displays a cutting pattern 521 in the form of a circular helix. The cutting pattern is depicted by, while repeatedly carrying out a circular scan in X-Y plane, carrying out a continuous shift of the circular scan in a Z-axis direction. A cut surface which comprises a part of a lateral surface of a cylindrical columnar work having a center line in parallel to the Z-axis is obtained through the use of the cutting pattern formed in this way. Parameters to be specified in the processing details dialog tab 412 are, in addition to those specified upon specification of the “non-shift,” the number of circular scans, a pitch of shift and a cutting direction. Further, as shown in FIG. 39, when specifying the “intermittent shift” in the shift type menu box 411, the display window 202 displays a cutting pattern 522 comprising an aggregation of a number of circles in parallel to an X-Y plane which are arranged at regular pitches in the Z-axis direction. The same parameters specified upon specification of the “continuous shift” are specified upon specification of the “intermittent shift.”

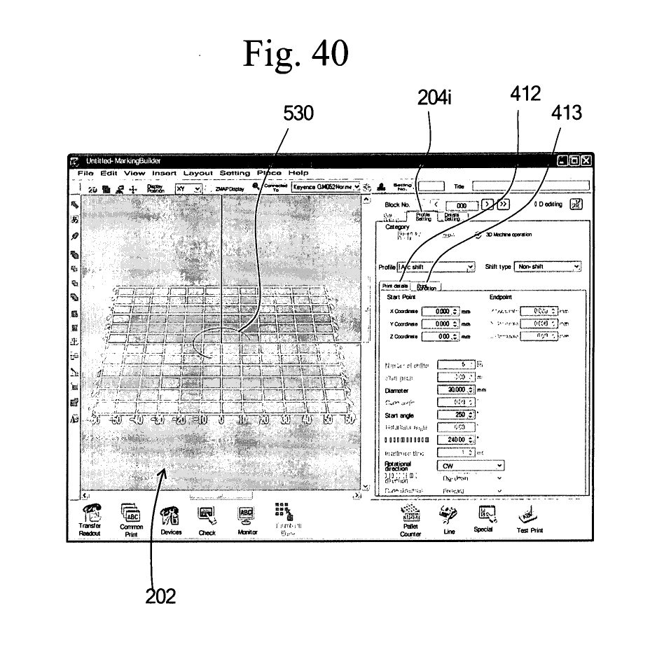

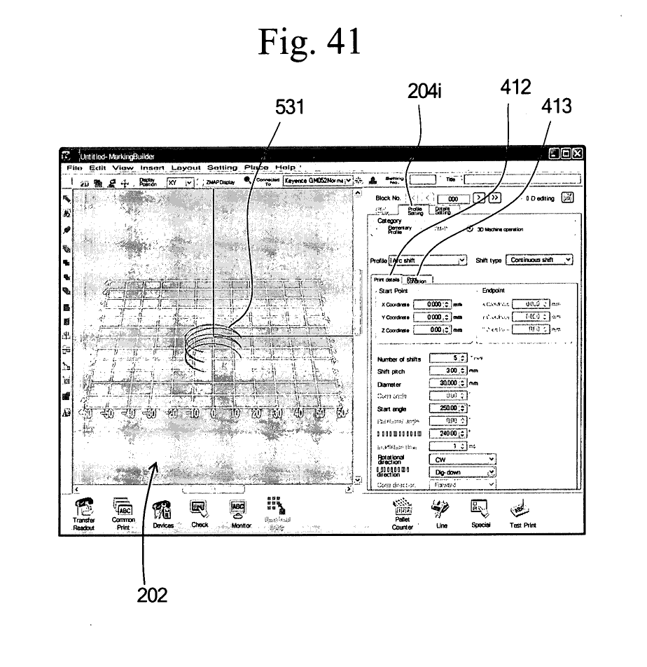

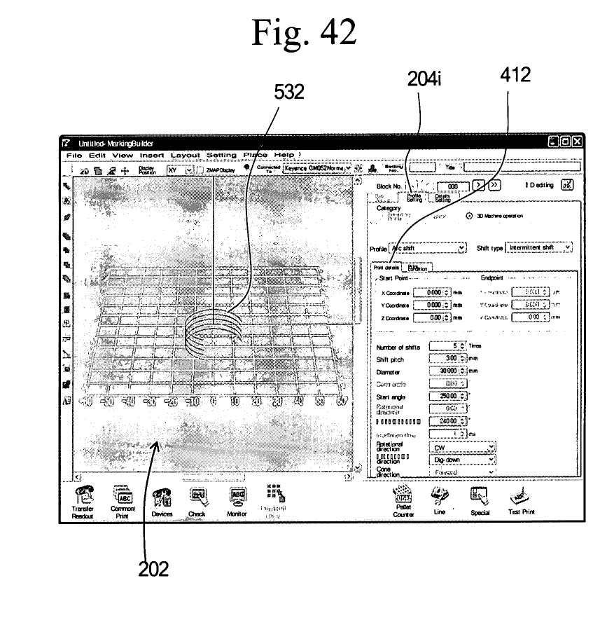

FIGS. 40 to 42 illustrate 3D edit mode display windows when the “circular arc shift” pattern is specified in the profile type menu box 410 in the profile setting dialog tab 204i. As shown in FIG. 40, when specifying the “non-shift” in the shift type menu box 411, the display window 202 displays a cutting pattern 530 in the form of a circular arc in parallel to an X-Y plane. Parameters to be specified in the processing details dialog tab 412 are X, Y and Z coordinates of a center of a circle (start point), a diameter of the circle, a start angle of the circle, an angle of opening of the arc and a rotational direction. In this instance, the “start angle” is translated as a start point or one of opposite endpoints from which a laser beam starts to draw a circular arc. The “angle of opening” is a center angle of an arc. As shown in FIG. 41, when specifying the “continuous shift” in the shift type menu box 411, the display window 202 displays a cutting pattern 531 which is a continuous polygonal line comprising a plurality of circular arcs each of which is at an angle with an X-Y plane. The cutting pattern is depicted by, while reciprocally making a continuous line drawing in a same circular arcuate path in an X-Y plane, continuously shifting the line drawing in the Z-axis direction so as to draw a pattern according to a specified profile type with a single stroke. A cut surface which comprises a part of a lateral surface of a cylindrical columnar work having a center line in parallel to the Z-axis is obtained through the use of the cutting pattern formed in this way. In this case, parameters to be specified in the processing details dialog tab 412 are, in addition to those specified upon specification of the “non-shift,” the number of reciprocating shifts, a pitch of shift and a cutting direction (a dig down direction or a dig up direction). In this instance, the “rotational direction” used as to the “continuous shin” is a direction in which a laser beam initially travels to draw a circular arc. Further, as shown in FIG. 42, when specifying the “intermittent shift” in the shift type menu box 411, the display window 202 displays a cutting pattern 532 comprising an aggregation of a number of circular arcs which are arranged at regular pitches in the Z-axis direction. The same parameters specified upon specification of the “continuous shift” are specified when specifying the “intermittent shift.”

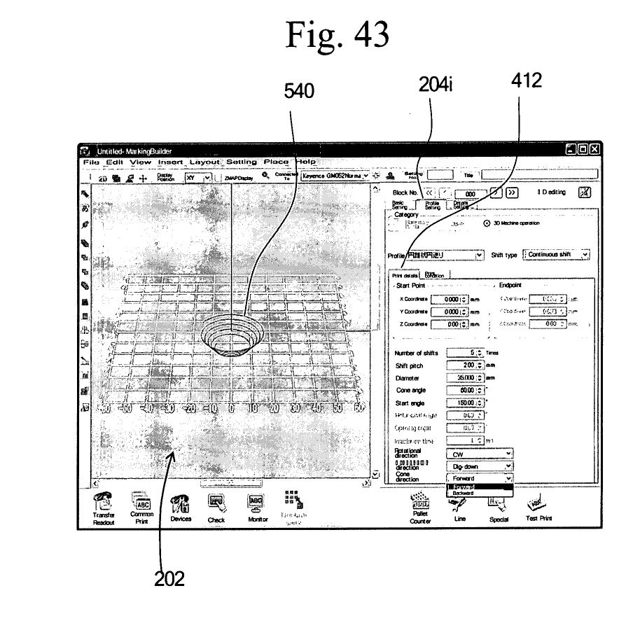

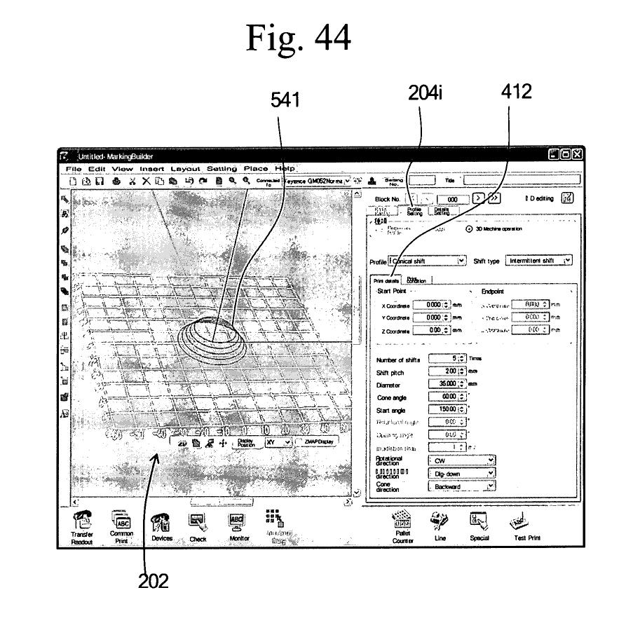

FIGS. 43 and 44 illustrate 3D edit mode display windows when the “conical circle shift” pattern is specified in the profile type menu box 410 in the profile setting dialog tab 204i. When specifying the “non-shift” in the shift type menu box 411, the display window 202 displays the same cutting pattern as when specifying the “circle shift” pattern in the profile type menu box 410 and the “non-shift” in the shift type menu box 411 show in FIG. 37. On the other hand, as shown in FIG. 43, when specifying the “continuous shift” in the shift type menu box 411, the display window 202 displays a cutting pattern 540 which is a continuous line of conical helix comprising a plurality of circles gradually increasing in diameter each of which is at an angle with an X-Y plane. The cutting pattern is depicted by, while repeatedly making a line drawing in a circular path in an X-Y plane, continuously shifting the line drawing in Z-axis direction coincidentally with increasing the diameter of the circular path so as thereby to draw a continuous line of conical helix. A cut surface which comprises a part of a lateral surface of a conical work or a frustconical work is obtained through the use of the cutting pattern formed in this way. In this case, parameters to be specified in the processing details dialog tab 412 are X, Y and Z coordinates of a center and a diameter of base circle (start point), the number of shifts, a pitch of shift, a cone angle, a start angle, a rotational direction, a cutting direction (a dig-own direction or a dig-up direction) and a cone direction (a forward direction or a backward direction). In this instance, the “cone angle” is an angle between a cone axis and a mother line of cone which corresponds to a change rate of a cross sectional diameter of a cone. The “forward” direction is a direction in which a cross sectional diameter of a cone becomes smaller as drawing apart from the laser processing head 110, and the “backward” direction is a direction in which a cross sectional diameter of a cone becomes larger as drawing apart from the laser processing head 110. Further, as shown in FIG. 44, when specifying the “intermittent shift” in the shift type menu box 411, the display window 202 displays a cutting pattern 541 comprising an aggregation of a number of circles gradually decreasing in diameter each of which is in parallel to an X-Y plane and which are arranged at regular pitches in the Z-axis direction. The same parameters specified upon specification of the “continuous shift” are specified upon specification of the “intermittent shift.” The cone direction specified is the forward direction in FIG. 43 and the backward direction in FIG. 44. The same parameters specified upon specification of the “continuous shift” are specified when specifying the “intermittent shift.”

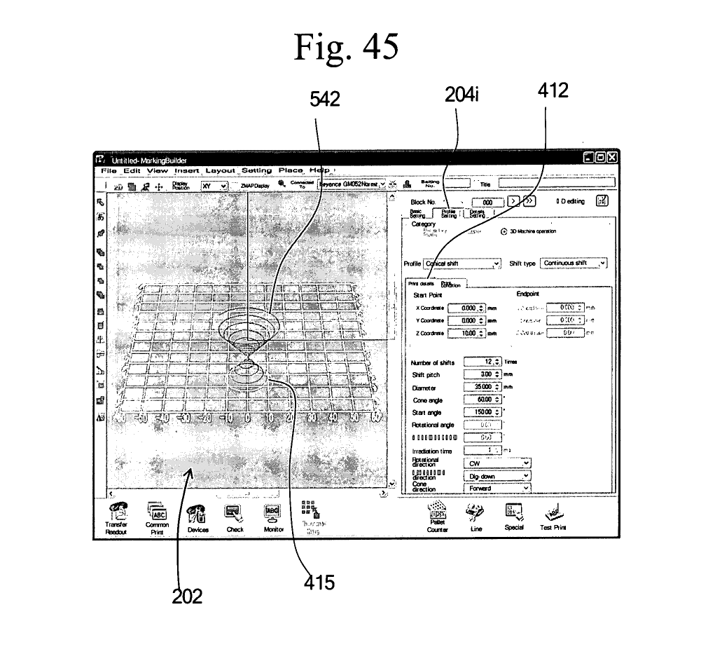

FIG. 45 shows a cutting pattern 542 which is formed by increasing the number of shifts and a shift pitches from those specified for the cone shaped cutting pattern 540 shown in FIG. 43. The cutting pattern comprises two cone patterns which have cone points in contact with each other in a common cone axis. The cone pattern 415 is displayed in different color because it is beyond a process able area which is a space predetermined as a spatial location relatively to the laser processing head 110. For instance, the processable area is defined as a rectangular space having faces in parallel to the X-Y plane.

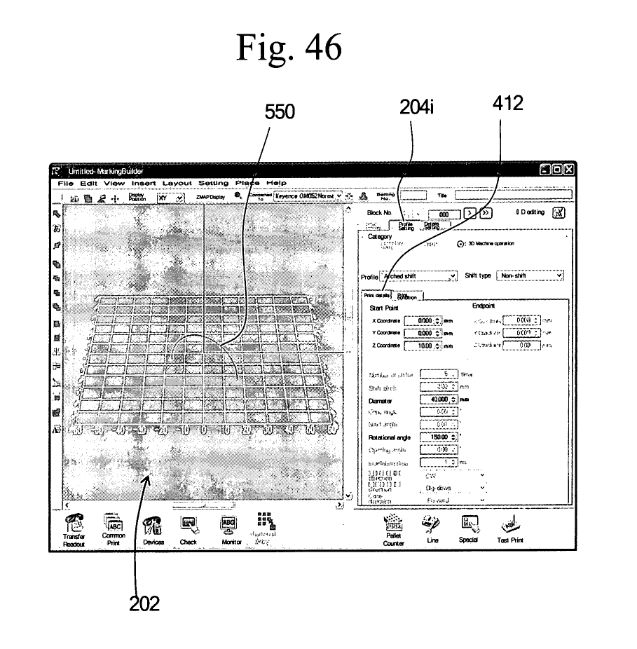

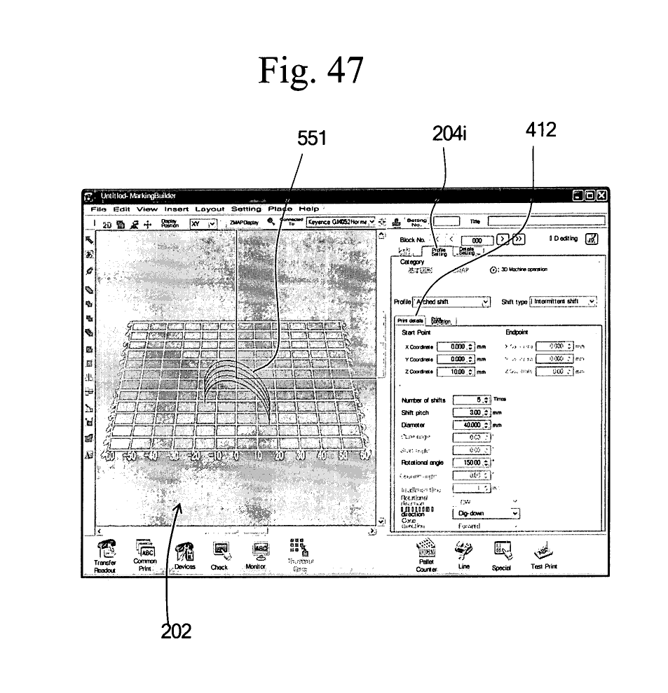

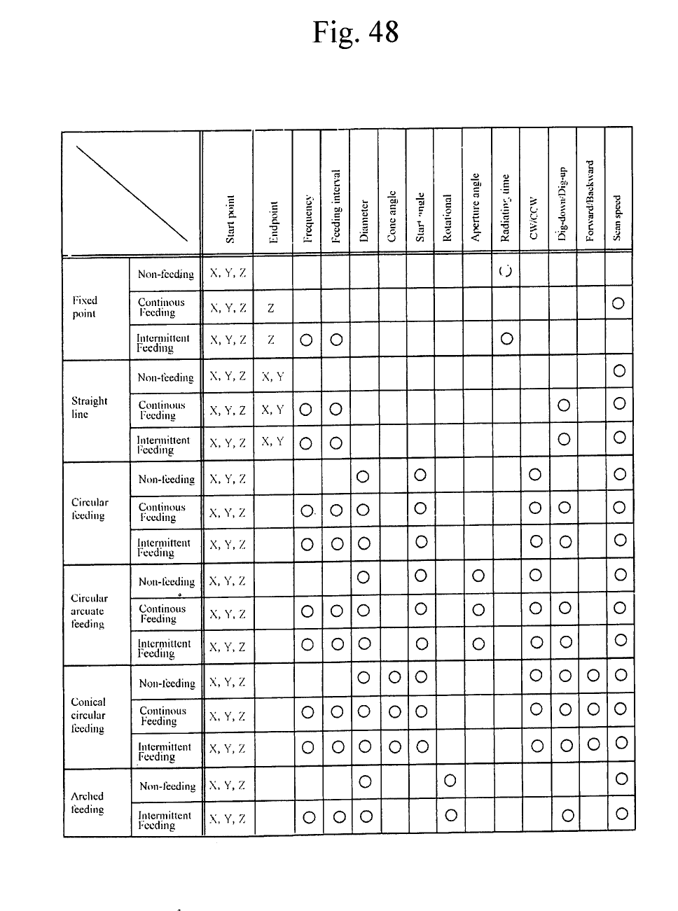

FIGS. 46 and 47 illustrate 3D edit mode display windows when the “arched shift” pattern is specified in the profile type menu box 410 in the profile setting dialog tab 204i. When specifying the “arched shift” pattern, the shift type menu box 411 puts the “non-shift” and the “intermittent shift” specifiable but the “continuous shift” inavailable. As shown in FIG. 46, when specifying the “non-shift” in the shift type menu box 411, the display window 202 displays a cutting pattern in the shape of arch. That is, the arched pattern is a semicircle which is formed on a side of the laser processing head 110 by cutting a circle in a plane perpendicular to the X-Y plane completely in half. In the case of specifying profile types other then the “arched shift” pattern, when the shift type of the “non-shift” is specified, no scan is carried out in the Z-axis direction. However, in the case of specifying the “arched shift” pattern, since an arched pattern has a height in the Z-axis direction in its own attribute, a scan is carried out in the Z-axis direction even when the shift type of the “non-shift” is specified. Such the arched pattern is suitably applied to a stripping machine for cutting a cladding sheath of an insulated wire having a circular cross section without damaging a core wire. In case of the “non-shift” when specifying the “arched shift” pattern as a profile type, parameters to be specified in the processing details dialog tab 412 are X, Y and Z coordinates and a diameter of a circle and a rotational angle. The rotational angle used to define an orientation of an arch is set to, for example, an angle at which a cutting-plane line along which a circle is cut in half meets the X-axis. On the other hand, as shown in FIG. 47, when specifying the “intermittent shift” in the shift type menu box 411, the display window 202 displays a cutting pattern 551 comprising an aggregation of a number of semicircles which are arranged at regular pitches in the Z-axis direction. An arched cutting surface extended in the Z-axis is obtained through the use of the cutting pattern formed in this way. Parameters to be specified in the processing details dialog tab 412 are, in addition to X, Y and Z coordinates and a diameter of a circle and a rotational angle, the number of shifts in the Z-axis direction, a pitch of shift and a citing direction (a dig-down direction or a dig-up direction). Such an arched pattern is suitably applied to a stripping machine for cutting a thick cladding sheath of an insulated wire.

FIG. 58 is a table showing settable parameters for combinations of profile types and shift types. Settable parameters are indicated by circle. X, Y and Z indicates that the respective coordinates are settable.

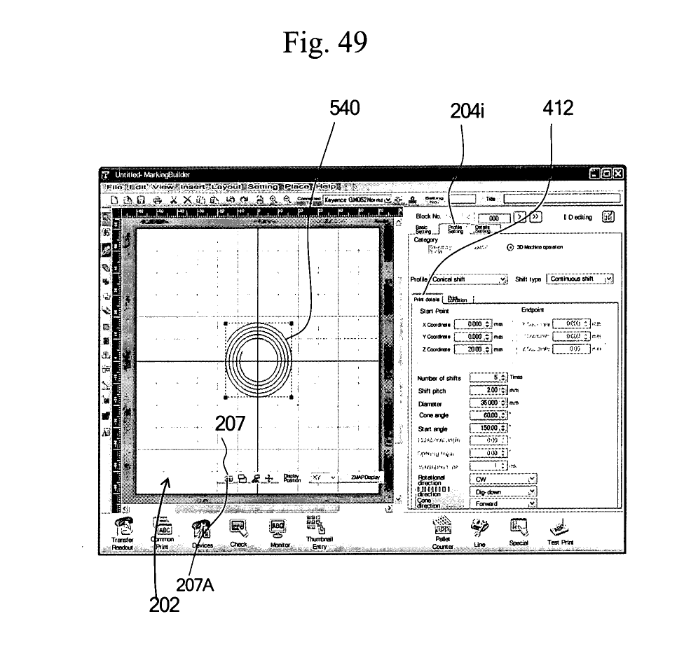

FIG. 49 illustrates a 3D edit mode display window in the 2D representation mode. The 2D representation mode is gained by clicking the representation switch button 207A in the floating tool bar 207 in the 3D edit mode display window in the 2D representation mode shown in, for example, FIG. 43. When a three-dimensional cutting pattern 540 is displayed in two-dimensions in the display window 202, the cutting pattern 540 can be shifted to a destination by specifying the destination on the display window 202 by the use of pointing means without specifying coordinates of the destination. In this instance, it is performed to change X and Y coordinates of the cutting pattern 540 by drag-and-drop of the cutting pattern 540 to the destination. However, a three-dimensional cutting pattern displayed in three dimensions can not be shifted in position in the 3D edit mode display window even by the use of pointing means. This is because, since a destination which is specified as a location in the 3D edit mode display window in the 3D representation mode represents a straight line in a three-dimensional space, it is impossible to uniquely define the destination. Therefore, in the case of 3D representation, the processing data setting program forbids drag-and-drop of a cutting pattern represented in three dimensions so as thereby to prevent users from shifting the cutting pattern contrary to the user's intention. On the contrary, in the case of 2D representation, since a cutting pattern is displayed in an X-Y coordinate plane, a destination specified in the display window 202 by the user uniquely defines X and Y coordinates of the destination, a shift of cutting pattern is carried out by the use of pointing means which is easy to operate.

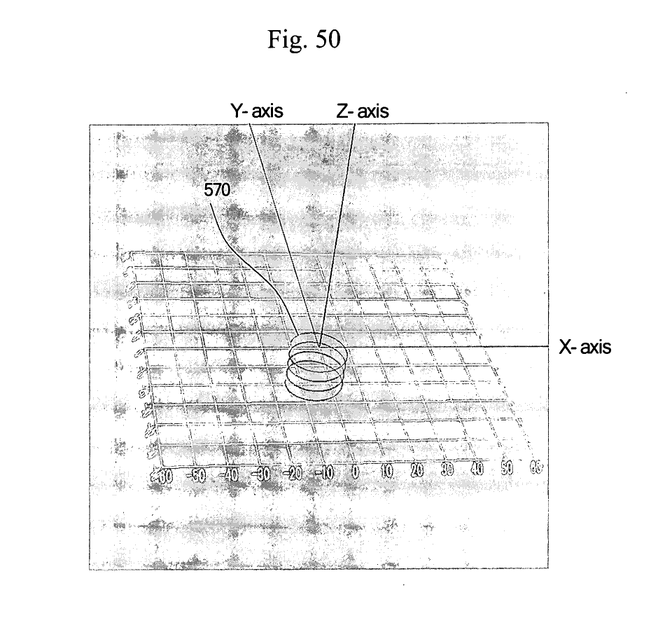

FIG. 50 illustrates a display window in which a three-dimensional cutting pattern 570 with which an inside of a transparent solid work. In the case where a work is capable of transmitting a laser beam, it is possible to form an intricate cut fine other than a straight line in the interior of the transparent solid work. That is, in the case where a pitch at which a laser beam is shifted is sufficiently larger than a width of a cutting pattern which depends upon laser power and/or a scan speed, a cut pattern formed with the cutting pattern inside the solid work is not a surface but a line which is the cutting pattern itself.

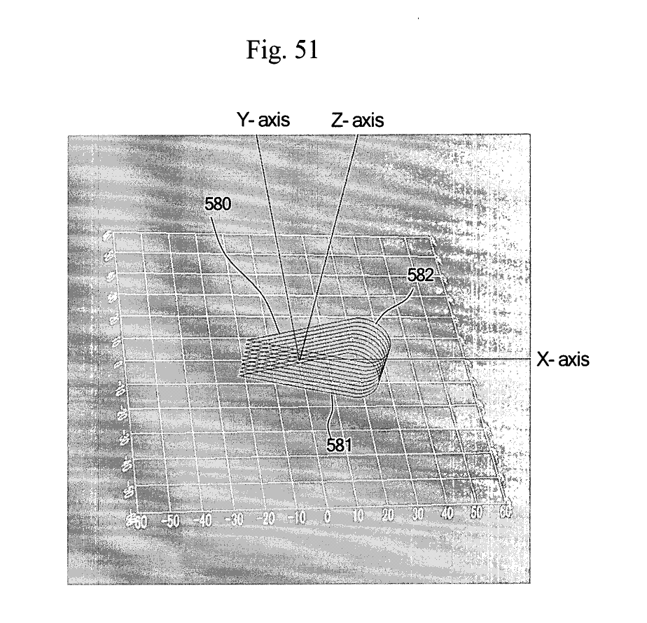

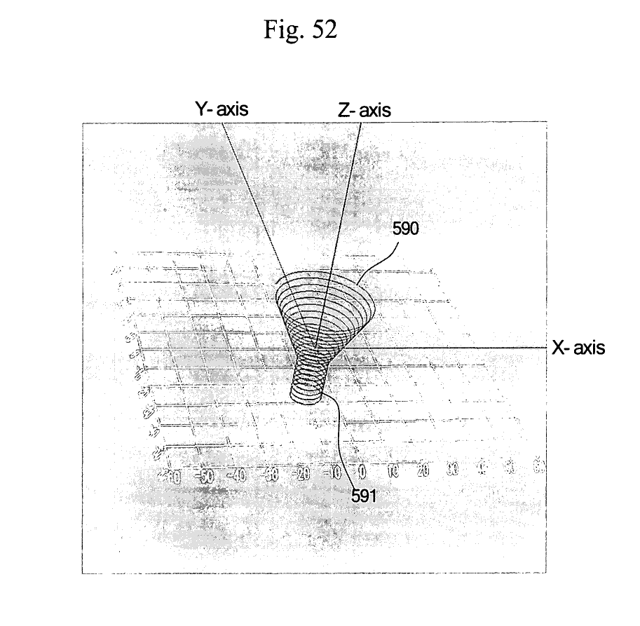

FIGS. 51 and 52 show composite three-dimensional cutting patters each of which comprises a combination of two or more than two three-dimensional cutting patterns. The composite three-dimensional cutting pattern shown in FIG. 51 comprises a combination of three cutting patterns, namely cutting patterns 580 and 581 which are created by intermittently shifting a straight line and a cutting pattern 582 which is created by intermittently shifting a circular arc. A composite three-dimensional cutting patterns like this is created by specifying available profile types, i.e. two straight lines and a circular arc, and specifying identical parameters about Z-axis scan, i.e. a Z coordinate, a shift type, a shift pitch and the number of shifts, for the respective profile types. It is of course permitted to specify different parameters about Z-axis parameters according to composite three-dimensional cutting patterns. The composite three-dimensional cutting pattern shown in FIG. 52 comprises a combination of two cutting patterns, namely a cutting pattern 590 which is created by continuously shifting a cone shift pattern and a cutting pattern 591 which is created by continuously shifting a circle, adjacent to each other. In these ways, a variety of composite three-dimensional cutting patterns which are not included in the available options provided in the profile type menu box 410 can be created.

The processing data generating means 77A generates laser processing data for representing a three-dimensional cutting pattern according to a two-dimensional cutting pattern and information about a shift which are specified by users. That is, the laser processing data contains data for controlling the X-axis scanner, the Y-axis scanner and the Z-axis scanner on the basis of the three-dimensional pattern.

As just described in detail above, a two-dimensional processing pattern is determined by specifying a profile type and parameter for defining a profile. A shift of a laser beam is determined by specifying parameters such as a type of shift, a shift pitch, the number of shifts, a processing direction and the like. A three-dimensional processing pattern is provided by, while repeatedly making a scan in a pattern in a two-dimensional X-Y plane, continuously or intermittently shifting the pattern in a Z-axis direction in synchronism with the two-dimensional scan. Referring to the laser processing system, X-axis scanner and the Y-axis scanner are controlled according to the two-dimensional pattern and, however, the Z-axis scanner is controlled by the shift information. Providing a description of the laser processing system 100, in the case of an intermittent shift, a laser beam is interrupted every time the two-dimensional scan is performed once and varied in focus distance by one shift pitch during the interruption. On the other hand, in the case of a continuous shift, while scanning with a laser beam is coincidentally performed in the X-Y plane and the Z-axis direction and the laser beam is continuously varied in focus distance by one shift pitch while the two-dimensional scan is performed once. In this way, it is realized to achieve precise laser processing of work surfaces in three-dimensional patterns.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A laser processing data generating system for generating three-dimensional laser processing data based on which a three-dimensional laser processing system is controlled so that two-dimensional scanning means scans a work surface in two dimensions by a laser beam and focal distance varying means varies a focal distance of said laser beam, said laser processing data generating system comprising:
subject pattern specifying means for specifying, at a user's option, subject pattern information about a two-dimensional subject pattern and a processing surface profile of a work which is processed by said three-dimensional laser marking system;
subject pattern data generating means for generating data based on which said two-dimensional scanning means and said focal distance varying means are controlled according to subject pattern information and said processing surface profile, respectively;
processing pattern specifying means for specifying, at a user's option, a two-dimensional processing pattern and a shift pitch at which said two-dimensional processing pattern is shifted; and
processing pattern data generating means for generating said processing data so that, while said two-dimensional scanning means repeats a scan with said two-dimensional processing pattern, said focal distance varying means varies said focal distance at said shift pitch in synchronism with said scan with said two-dimensional processing pattern.

2. The laser processing data generating system as defined in claim 1, and further comprising rate-of-change specifying means for specifying, at a user's option, a rate of change in size of said processing pattern, wherein said processing pattern data generating means generates said processing data so that said two-dimensional processing pattern is changed in size at said rate of change every shift of said two-dimensional processing pattern.

3. The laser processing data generating system as defined in claim 1, and further comprising shift frequency specifying means for specifying the number of shifts of said scan with said two-dimensional processing pattern, wherein said processing pattern data generating means generates said processing data so that said scan with said two-dimensional processing pattern is repeated the number of shift.

4. The laser processing data generating system as defined in claim 1, wherein said two-dimensional processing pattern is continuously shifted.

5. The laser processing data generating system as defined in claim 1, wherein said two-dimensional processing pattern is intermittently shifted.

6. A method of generating three-dimensional laser processing data based on which a three-dimensional laser processing system is controlled so that two-dimensional scanning means scans a work surface in two dimensions by a laser beam and focal distance varying means varies a focal distance of said laser beam, said laser processing data generating method comprising the steps of:
specifying at a user's option, subject pattern information about a two-dimensional subject pattern and a processing surface profile of a work which is processed by said three-dimensional laser marking system;
generating data based on which said two-dimensional scanning means and said focal distance varying means are controlled according to subject pattern information and said processing surface profile, respectively;
specifying, at a user's option, a two-dimensional processing pattern and a shift pitch at which said two-dimensional processing pattern is shifted; and
generating said processing data so that, while said two-dimensional scanning means repeats a scan with said two-dimensional processing pattern, said focal distance varying means varies said focal distance at said shift pitch in synchronism with said scan with said two-dimensional processing pattern.

7. A computer program for generating three-dimensional laser processing data based on which a three-dimensional laser processing system is controlled so that two-dimensional scanning means scans a work surface in two dimensions by a laser beam and focal distance varying means varies a focal distance of said laser beam, said computer program for generating three-dimensional laser processing data comprising:
a function of specifying, at a user's option, subject pattern information about a two-dimensional subject pattern and a processing surface profile of a work which is processed by said three-dimensional laser marking system;
a function of generating data based on which said two-dimensional scanning means and said focal distance varying means are controlled according to subject pattern information and said processing surface profile, respectively;
a function of specifying, at a user's option, a two-dimensional processing pattern and a shift pitch at which said two-dimensional processing pattern is shifted; and
a function of generating said processing data so that, while said two-dimensional scanning means repeats a scan with said two-dimensional processing pattern, said focal distance varying means varies said focal distance at said shift pitch in synchronism with said scan with said two-dimensional processing pattern.

8. A laser marking system for marking a work surface with a pattern by a laser beam, said laser marking system comprising:
two-dimensional scanning means for scanning said work surface in two dimensions by a laser beam;
focal distance varying means for varies a focal distance of said laser beam by varying a beam size of said laser beam;
subject pattern specifying means for specifying, at a user's option, subject pattern information about a two-dimensional subject pattern and a processing surface profile of a work which is processed by said three-dimensional laser marking system;
marking control means for controlling said two-dimensional scanning means and said focal distance varying means are controlled according to subject pattern information and said processing surface profile, respectively;
processing pattern specifying means for specifying, at a user's option, a two-dimensional processing pattern and a shift pitch at which said two-dimensional processing pattern is shifted; and
processing control means for controlling said two-dimensional scanning means and said focal distance varying means so that, while said two-dimensional scanning means repeats a scan with said two-dimensional processing pattern, said focal distance varying means varies said focal distance at said shift pitch in synchronism with said scan with said two-dimensional processing pattern.
